(19) United States
(12) Patent Application Publication
(10) Pub. No.: US 2024/0340842 A1
(43) Pub. Date: Oct. 10, 2024

(54) WIRELESS STATION ZONING

(71) Applicant: MAXLINEAR, INC., Carlsbad, CA (US)

(72) Inventor: Srinivasan Ganapathy, Tamil Nadu (IN)

(73) Assignee: MAXLINEAR, INC., Carlsbad, CA (US)

(21) Appl. No.: 18/621,022

(22) Filed: Mar. 28, 2024

(30) Foreign Application Priority Data
Apr. 1, 2023 (IN) 202311025064

(51) Int. Cl. H04W 64/00

(52) U.S. Cl. CPC H04W 64/00

(57) ABSTRACT

Multiple methods for determining a location of a STA operating on a mesh wireless network are described herein. A STA finder is used to monitor changes in received signal strength at each access point of a group of access points operating the mesh wireless network. The changes in received signal strength are then utilized to determine a location of STAs operating on the mesh wireless network. Methods for identifying poor performance areas on the mesh wireless network using the position information and then providing recommendations for improving the performance of the mesh wireless network are also described herein.

### CROSS-REFERENCE TO RELATED APPLICATIONS

This application claims priority to Indian Provisional Patent Application No. 202311025064 filed on Apr. 1, 2023 and entitled “WIRELESS STATION ZONING”, which is incorporated by reference in its entirety.

### TECHNICAL FIELD

The embodiments discussed in the present disclosure are related to a station finder used for identifying the physical locations of STAs operating on a mesh wireless network.

### BACKGROUND

Unless otherwise indicated herein, the materials described herein are not prior art to the claims in the present application and are not admitted to be prior art by inclusion in this section.

Routers are used in wireless communication to direct traffic between networks to an end user. Traffic may take the form of data packets that may be forwarded from one router to another router through networks such as the internet. Routers may not operate at an optimal level when the signal quality is poor. Wireless mesh networks introduced the ability for users to improve signal quality in larger locations or locations with difficult to cover regions using multiple access points (APs) that generally take the form of a wireless gateway and one or more wireless repeaters. Unfortunately, some users may not effectively position the APs in a configuration that achieves Wi-Fi® coverage for the location without leaving areas with reduced or no connectivity. Furthermore, conventional Wi-Fi® location services are often not accurate enough to help identify areas with reduced or no Wi-Fi® connectivity. This is particularly problematic where for example the use of secondary location sensors such as GPS is blocked or degraded due to the mesh wireless network being located in a location where some characteristics of the location or surrounding structures block or degrade access to the GPS signal. For these reasons, methods for helping a user improve mesh network configurations are desirable.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This paper describes various embodiments that relate to methods for determining a location of multiple STAs operating on a mesh wireless network. In some embodiments, that position data is used to help analyze and improve performance and/or coverage of the mesh wireless network.

A STA finder is described and includes a processing device configured to: monitor signal strengths associated with a STA for each of a group of access points supporting a wireless mesh network; detect that a first signal strength for the STA at a first access point of the group of access points is passing through a threshold signal strength at a first time; and determine a location of the STA relative to the first access point at a second time offset from the first time based on detected changes in the first signal strength and/or a second signal strength for the STA at the second time.

A method is described and includes monitoring signal strengths associated with a STA for each of a group of access points supporting a wireless mesh network; detecting that a first signal strength for the STA at a first access point of the group of access points is increasing through a threshold signal strength at a first time; and determining a location of the STA relative to the first access point at a second time prior to the first time based on changes in the first signal strength and/or a second signal strength for the STA at the second time.

Another method is disclosed that includes: monitoring signal strengths associated with a STA for each of a group of access points supporting a wireless mesh network; detecting that a first signal strength for the STA at a first access point of the group of access points is decreasing through a threshold signal strength at a first time; and determining a location of the STA relative to the first access point at a second time following the first time based on changes in the first signal strength for the STA and/or a second signal strength for the STA at the second time.

An additional method is disclosed that includes monitoring signal strengths associated with a STA for a group of access points supporting a wireless mesh network operating on a property; comparing the monitored signal strengths associated with the STA with previously monitored signal strengths associated with locations on the property; and in response to the monitored signal strengths at a first time matching one or more of the previously monitored signal strengths, determining a location of the STA on the property at the first time based on the matching one or more of the previously monitored signal strengths being associated with the location.

A STA finder, is disclosed and includes a processing device configured to monitor signal strengths associated with a STA for a group of access points supporting a wireless mesh network operating on a property; compare the monitored signal strengths associated with the STA with previously monitored signal strengths associated with locations on the property; and in response to the monitored signal strengths at a first time matching one or more of the previously monitored signal strengths, determine a location of the STA on the property at the first time based on the matching one or more of the previously monitored signal strengths being associated with the location.

Another method is disclosed that includes: monitoring performance of a wireless mesh network operating on a property; and in response to identifying a region of the property where the performance of the wireless mesh network falls below a predetermined threshold, recommending movement of an access point (AP) of a group of APs to improve performance of the wireless network in the identified region.

A STA finder is disclosed and includes a processing device configured to: monitor performance of a wireless mesh network operating on a property; and in response to identifying a region of the property where the performance of the wireless mesh network falls below a predetermined threshold, recommend movement of an access point (AP) of a group of APs to improve performance of the wireless network in the identified region.

Other aspects and advantages of the described embodiments will become apparent from the following detailed description taken in conjunction with the accompanying drawings which illustrate, by way of example, the principles of the described embodiments.

### BRIEF DESCRIPTION OF THE DRAWINGS

Example embodiments will be described and explained with additional specificity and detail through the use of the accompanying drawings in which:

FIG. 1A shows how an outside-in analysis can be used to determine when a STA is moving from being near a first access point to being near another access point;

FIG. 1B shows a block diagram illustrating how a user may place input using a user interface 152 to a cloud application;

FIGS. 2A-2C show a series of inputs a user can make during onboarding of a Wi-Fi® mesh network having N access points;

FIG. 3 shows how in some embodiments, at runtime, various parameters may be shared from the mobile application running on the device being used as a STA finder to an algorithm that is hosted on the same server;

FIG. 4 shows how in some embodiments, the quarter-sphere or hemisphere may be defined by aligning a secondary router directly below a primary router/AP;

FIG. 5 illustrates a series of communications that can be performed by a STA finder architecture, when a STA satisfies an entry condition for a router for a first time in a particular movement of the STA (i.e., at a time defined as t₂), then a previous time (i.e., a time defined as t₁) may be computed;

FIG. 6 shows multiple exemplary STA zones possible if at a time t₁ SR is available and RSSI values for PR are increasing;

FIG. 7A shows multiple exemplary STA zones possible for the depicted configuration of three available APs;

FIGS. 7B-7D show a step by step method for identifying a STA zone from FIG. 7A;

FIG. 8 shows multiple exemplary STA zones possible for the depicted configuration of three available APs;

FIG. 9 shows multiple exemplary STA zones possible for the depicted configuration of three available APs, where AP 902 is the PR, AP 904 is the SR and AP 906 is the TR;

FIG. 10 shows multiple exemplary STA zones possible for a depicted configuration of two available APs;

FIG. 11 shows multiple exemplary STA zones possible for a depicted configuration of three available APs;

FIG. 12 shows multiple exemplary STA zones possible for another depicted configuration of three available APs;

FIG. 13 shows multiple exemplary STA zones possible for a depicted configuration of three available APs;

FIGS. 14A-14E shows another exemplary method for approximating the size and arrangement of STA zones relative to multiple APs;

FIGS. 15A-15I show how STA zones can be selected relative to a spherical outline surrounding a first AP with inner and outer radii based on RSSI values for a second AP for three AP configurations;

FIG. 16 shows a flow chart describing a method performed by the STA finder when a particular STA or a STA hosting the STA finder does not enter into or exit a CZ of an access point during a period of time during which RSSI data is collected;

FIG. 17 shows a flow chart indicating how a mobile app may operate;

FIG. 18A shows an exemplary floorplan that includes multiple APs;

FIG. 18B shows how a heat zone map can be generated based on RSSI data;

FIG. 19A shows a floorplan that includes three APs as well as a path traversed by a STA for the purpose of evaluating Wi-Fi® coverage across the floorplan;

FIG. 19B shows a line graph representing Wi-Fi® coverage performance during a period of about 30 minutes;

FIG. 19C shows a heat map generated based on the RSSI data collected as described previously and overlaid with indicia indicating locations or zones with high usage;

FIG. 19D shows another exemplary path performed for the same floorplan and AP layout used in FIGS. 18A-19C;

FIG. 19E, in a similar manner to FIG. 19B, shows a line graph representing Wi-Fi® coverage performance but for a period of about 45 minutes.

FIG. 19F also includes multiple dashed ellipses identifying darker or more heavily utilized STA zones within a heat map;

FIG. 20A shows how input may be collected from a user equipment (UE) by first getting the floor-map, floor dimensions, and access point locations from a user interface;

FIG. 20B shows how a topology diagram may be used to display relative access point locations;

FIG. 20C shows how a “!” symbol 2016 may be used to indicate that an access point should be relocated closer or proximate to a selected static client;

FIG. 20D shows how an exemplary arrow can be used to both indicate relocation is recommended and provide the direction of movement for the access point to increase the coverage and/or performance of the mesh wireless network;

FIG. 21 illustrates a diagrammatic representation of a machine in the example form of a computing device; and

FIG. 22 shows a flow diagram describing a method for determining a location of a STA operating on a mesh wireless network.

### DETAILED DESCRIPTION

A user may position a router or access point (AP) in a residential or commercial property without knowledge of whether the router will provide a desired coverage level. Furthermore, a user may not know where to relocate a router based on the locations of the power outlets at a particular property or other obstructions or property features limiting the positioning of the router.

In some embodiments, a device (e.g., a station (STA) finder device) may include a processing device that may be configured to: identify one or more access points (APs) (e.g., routers or Wi-Fi® extenders) having a location in a layout; receive a signal strength sometimes referred to as a received signal strength indicator (RSSI) from the one or more access points (AP) (e.g., routers); identify a primary AP based on the signal strength; compute a later time point associated with movement across a threshold of a primary AP confidence zone; compute a primary AP distance for the primary AP; compute a previous time point associated with the primary AP; compute a distance for the previous time point; and compute a STA zone for the previous time point. The STA zone defines a spatial region relative to the primary AP occupied by the device at the previous time point. A size of the STA zone generally varies based on a certainty of the location of the device at the previous time point.

In some embodiments, a Wi-Fi network may be operable with two or more access points (APs). A STA finder device may be in communication with at least one of the APs. A processor of or associated with the STA finder device may be configured to execute a STA finder algorithm to identify an approximate location for each connected STA. This approximate location is referred to herein as a STA zone.

In some embodiments, a STA finder device may be configured to identify poor placement of AP nodes (e.g., routers) and coverage shortages in networks. Poor placement of AP nodes (e.g., routers) and coverage shortages in networks may be identified STA zone instances that correlating with poor user-experience windows.

In some embodiments, the STA finder device may receive inputs from an AP or from a user. As shown in Table (1) below, the input may include: (i) the STA finder device received signal strength indicator (RSSI) time series from a number of APs (e.g., routers), and (ii) an AP (e.g., router) list, with each AP (e.g., router having a location in at least two dimensions, and (iii) a layout having a shape in at least two-dimensions.

TABLE 1
STA Finder Device Inputs

| Input name | Source |
|---|---|
| STA RSSI timeseries | Each router box sends to STA finder module |
| from applicable routers | |
| Routers list and location | [x, y] location (chosen by the user) in a |
| | rectangle or square layout (chosen by the user) |

In some embodiments, the STA finder device may output each STA's location as a zone comprising a shape selected from different shapes at a selected time. The STA finder device output for each STA may include: (i) the primary router (PR), (ii) the secondary router (SR), (iii) the tertiary router (TR) (if used), (iv) the primary router distance (PRD) from the STA, (v) the secondary router distance (SRD) from the STA, (vi) the tertiary router distance (TRD) from the STA (if used), (vii) the shape for the STA including a quarter-sphere, a hemisphere, a sphere, or a cylinder, (viii) a tilt for the shape of the STA (e.g., towards, left, right, away for a shape being a hemisphere or cylinder, or q1, q2, q3, q4 for a shape being a quartersphere), (ix) a radius for the STA (i.e., a STA's distance from the PR), (x) a confidence index (with respect to accuracy and precision of location of the STA), (xi) a timestemp (ts), or (xii) a STA mac address (STA mac).

TABLE 2
STA Finder Device Outputs

| Output | |
|---|---|
| parameter | Parameter meaning |
| PR | Primary router (strongest RSSI for STA) |
| SR | Secondary router(second stronger RSSI for STA) |
| TR | Tertiary router(third strongest RSSI for STA) |
| PRD | Primary router distance from STA |
| SRD | Secondary router distance |
| TRD | Tertiary router distance |
| zone | Sphere, hemisphere, quartersphere, cylinder |
| radius | Distance from PR(distance will come to effect based on the |
| | shape) |
| tilt | “towards”, “left”, “right”, “away” for “hsph” and “cylinder”. |
| | “q1”, “q2”, “q3”, “q4” for “qsph” |

In some embodiments, a STA finder algorithm may output a STA zone based on the movement between an AP (e.g., a router) and a STA device. There are three categories of movement between an AP and a STA device when moving STAs are tracked: (1) movement towards an AP (e.g., a router), (2) movement away from an AP (e.g., a router), and (iii) movement that may be neither towards nor away from an AP (e.g., a router).

In some embodiments, movement towards an AP may be computed using a number of operations including: (a) identify when a STA moves into a confidence zone for an AP, wherein the AP confidence zone may be a selected distance around the AP for which the router may have an RSSI above a threshold (e.g., 5 m, 8 m, or the like around an AP), (b) a time point, t₂, and a position (x, y) may be computed for when the STA moves across the threshold for the AP confidence zone (e.g., for a 5 m AP confidence zone, when the STA crosses a boundary of 5 m around the AP), (c) receive RSSI data associated with APs for which the threshold has been crossed and calculate the RSSI data into an RSSI data pattern that may be: (i) moving towards the AP (i.e., approaching the AP, or “approaching”), (ii) moving away from the AP (i.e., leaving the AP, or “leaving”), (iii) neither moving towards or away from the AP (i.e., neither approaching nor leaving the AP, or “neither”), and (d) calculate a time point, t₁, when the STA moves from near an AP to near a different AP (i.e., moving away from a first AP and moving towards a second AP). In this scenario, the time point t₂ may be used to calculate the time point t₁, wherein the time point t₁ is earlier in time than the time point, t₂.

In some embodiments, movement away from an AP may be computed using a number of operations including: (a) identify when a STA moves out of a confidence zone for the AP, wherein an outer boundary of the AP confidence zone may be a selected distance around the AP for which the router may have an RSSI above a threshold (e.g., 5 m, 8 m, or the like around an AP), (b) a time point, t₂, and a position (x, y) may be computed for when the STA moves across the outer boundary of the AP confidence zone (e.g., for a 5 m AP confidence zone, when the STA crosses the outer boundary of 5 m around the AP), (c) receive RSSI data associated with APs for which the threshold has been crossed and calculate the RSSI data into an RSSI data pattern that may be: (i) “approaching”, (ii) “leaving”, (iii) “neither”, and (d) calculate a time point, t₃, when the STA moves from near the AP to near a different AP (i.e., moving away from the first AP and moving towards a different AP). In this scenario, the time point t₂ where the STA crosses the CZ may be used to calculate the time point t₃, wherein the time point t₃ is later in time than the time point, t₂.

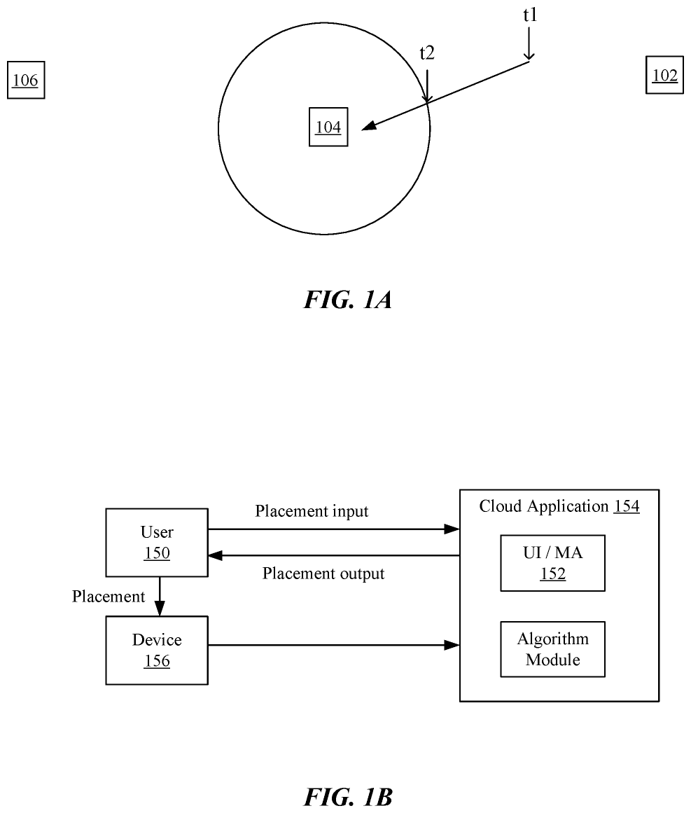

In some embodiments, an outside-in analysis can be used to determine when a STA is moving from being near an AP 102 to being near a different AP 104, as shown in FIG. 1A. The operations may include: (1) receive RSSI for each AP 102-106, (2) calculate a distance for each AP based on the RSSI data, (3a) calculate an angle between the x-axis and the line between a secondary AP and a tertiary AP (when a tertiary router is used), (3b) calculate the slope for each APs RSSI data by solving the first derivative of the least square error using Eq (1):

$$B = \frac{n ( \sum xy ) - ( \sum x ) ( \sum y )}{n ( \sum {x}^{2} ) - {( \sum x )}^{2}} \qquad Eq ( 1 )$$

where: (i) B is the calculated slope, (ii) n is the number of samples, (iii) x are the time samples, and (iv) y is the STA distance in meters. From this equation for the slope, B, an angle of the slope, Ø, may be calculated with respect to the x axis in the first quadrant using the equation: Ø=arctan (B). When the angle of the slope, θ, is less than about 160° (i.e., the slope is facing away from the AP), the STA may be leaving the AP because the STA at the later time point (i.e., t₂) has a position that is farther from R compared to the position of the STA at the earlier time point (i.e., t₁). That is, the angle between t₁ and t₂ is less than about 160° compared to the x axis in the first quadrant. When the angle of the slope, θ, is greater than about 197°, the STA may be approaching the AP because the STA at the later time point (i.e., t₂) has a position that is closer to R compared to the position of the STA at the earlier time point (i.e., t₁), as shown in FIG. 1A. When the angle of the slope, Ø, is greater than about 160° and less than about 197°, the STA may be neither approaching the AP nor leaving the AP because the STA at the later time point (i.e., t₂) has a position that is neither closer nor farther relative to the AP labeled R when compared to the position of the STA at the earlier time point (i.e., t₁).

In some embodiments, the operations may include an equidistant check in which the operation may check if the movement of the STA is towards or away from the mid-point of the line between the two routers (e.g., APs 102 and 104 as shown in FIG. 1A).

In some embodiments, when the PR and SR have been selected, the shape may be drawn by aligning the secondary router directly below the primary router. When the secondary router is positioned directly below the primary router (e.g., relative to the z axis), then the relative positions between the PR and the SR may include: (i) “opp” may be the hemisphere an opposite side of the SR and the PR (i.e., not between the PR and SR), (ii) “towards” may be the hemisphere between the PR and SR, (iii) “left” may be the hemisphere to the left of the PR and SR, (iv) “right” may be the hemisphere to right of the PR and the SR. Furthermore, the quarter-spheres may be defined as: (i) top-left (Q2), (ii) top-right (Q1), (iii) bottom-left (Q3), and (iv) bottom-right (Q4).

In some embodiments, as shown below, a straight angle, a complete angle, a right angle, and a three quarter angle may be defined as:

| | |
|---|---|
| #define STRAIGHT_ANGLE | 180 |
| #define COMPLETE_ANGLE | 360 |
| #define RIGHT_ANGLE | 90 |
| #define THREE_QUARTER_ANGLE | 270 |

In some embodiments, based on the definitions provided for a straight angle, a complete angle, a right angle, and a three quarter angle, and the definition for “angle” as being the angle between the x axis and the SR-TR line, the combinations may be correlated to the shapes based on Table (3) as shown below:

TABLE 3
Shape Computation

| Combination | Shape Computation |
|---|---|
| Approaching, | locale = STA_LOCALE_HSPH; |
| approaching, | sublocale = SUBLOCALE_OPP; |
| approaching | if (angle < (RIGHT_ANGLE / 2)) { |
| | } else if (angle < RIGHT_ANGLE) { |
| | sublocale = SUBLOCALE_LEFT; |
| | } else if (angle < (RIGHT_ANGLE + (RIGHT_ANGLE |
| | / 2))) { |
| | sublocale = SUBLOCALE_LEFT; |
| | } else if (angle < STRAIGHT_ANGLE) { |
| | sublocale = SUBLOCALE_LEFT \| |
| | SUBLOCALE_RIGHT; |
| | } else if (angle < (STRAIGHT_ANGLE + |
| | (RIGHT_ANGLE / 2))) { |
| | sublocale = SUBLOCALE_LEFT \| |
| | SUBLOCALE_RIGHT; |
| | } else if (angle < THREE_QUARTER_ANGLE) { |
| | sublocale = SUBLOCALE_RIGHT; |
| | } else if (angle < (THREE_QUARTER_ANGLE + |
| | (RIGHT_ANGLE / 2))) { |
| | sublocale = SUBLOCALE_RIGHT; |
| | } else { |
| | } |
| Approaching, | if(angle < (RIGHT_ANGLE / 2)) { |
| approaching, | locale = STA_LOCALE_QSPH; |
| leaving | sublocale = |
| | QSPH_SUBLOCALE_BOTTOMRIGHT; |
| | } else if (angle < RIGHT_ANGLE) { |
| | if |
| | (!is_sta_moving_equidistant_to_two_routers(t1_pr, t1_sr, |
| | t2_pr_inst, |
| | &ed)) { |
| | if (ed) { |
| | sublocale = |
| | QSPH_SUBLOCALE_BOTTOMRIGHT; |
| | locale = STA_LOCALE_QSPH; |
| | } else { |
| | sublocale = SUBLOCALE_RIGHT; |
| | locale = STA_LOCALE_HSPH; |
| | } |
| | } |
| | } else if (angle < (RIGHT_ANGLE + (RIGHT_ANGLE |
| | / 2))) { |
| | if |
| | (!is_sta_moving_equidistant_to_two_routers(t1_pr, t1_sr, |
| | t2_pr_inst, |
| | &ed)) { |
| | if (ed) { |
| | sublocale = |
| | QSPH_SUBLOCALE_BOTTOMRIGHT; |
| | locale = STA_LOCALE_QSPH; |
| | } else { |
| | sublocale = SUBLOCALE_RIGHT; |
| | locale = STA_LOCALE_HSPH; |
| | } |
| | } |
| | } else if (angle < STRAIGHT_ANGLE) { |
| | sublocale = SUBLOCALE_OPP; |
| | } else if (angle < (STRAIGHT_ANGLE + |
| | (RIGHT_ANGLE / 2))) { |
| | sublocale = SUBLOCALE_OPP; |
| Approaching, | if ((angle < (RIGHT_ANGLE / 2)) \|\| |
| approaching, | (angle > (THREE_QUARTER ANGLE + |
| neither a not 1 | (RIGHT_ANGLE / 2)))) { |
| | } else if (angle < RIGHT_ANGLE) { |
| | locale = STA_LOCALE_HSPH; |
| | sublocale = SUBLOCALE_RIGHT; |
| | } else if (angle > THREE_QUARTER_ANGLE) { |
| | locale = STA_LOCALE_HSPH; |
| | sublocale = SUBLOCALE_LEFT; |
| | } else if (angle > STRAIGHT_ANGLE) { |
| | locale = STA_LOCALE_HSPH; |
| | sublocale = SUBLOCALE_OPP; |
| | } else { |
| | locale = STA_LOCALE_HSPH; |
| | sublocale = SUBLOCALE_LEFT \| |
| | SUBLOCALE_RIGHT; |
| | } |

In some embodiments, by aligning the secondary router directly below the primary router relative to the z axis, the combinations may be correlated to the shapes as shown in the Table (4) below:

TABLE 4
Shape Computation

| Combination | Shape |
|---|---|
| Approaching, | if ((angle < (RIGHT_ANGLE / 2)) \|\| |
| leaving, | (angle > (THREE_QUARTER_ANGLE + |
| approaching | (RIGHT_ANGLE / 2)))) { |
| | } else if (angle < RIGHT_ANGLE) { |
| | if |
| | (!is_sta_moving_equidistant_to_two_routers(t1_pr, t1_tr, |
| | t2_pr_inst, |
| | &ed)) { |
| | if (ed) { |
| | sublocale = |
| | QSPH_SUBLOCALE_BOTTOMRIGHT; |
| | locale = STA_LOCALE_QSPH; |
| | } |
| | } |
| | } else if (angle > THREE_QUARTER_ANGLE) { |
| | if |
| | (!is_sta_moving_equidistant_to_two_routers(t1_pr, t1_tr, |
| | t2_pr_inst, |
| | &ed)) { |
| | if (ed) { |
| | locale = STA_LOCALE_QSPH; |
| | sublocale = |
| | QSPH_SUBLOCALE_BOTTOMLEFT; |
| | } |
| | } |
| | } |
| Approaching, | if ((angle > RIGHT_ANGLE) && (angle < |
| leaving, | THREE_QUARTER_ANGLE)) { |
| leaving | } else if (angle > THREE_QUARTER_ANGLE) { |
| | locale = STA_LOCALE_QSPH; |
| | sublocale = |
| | QSPH_SUBLOCALE_BOTTOMLEFT; |
| | } else if (angle < RIGHT_ANGLE) { |
| | locale = STA_LOCALE_QSPH; |
| | sublocale = |
| | QSPH_SUBLOCALE_BOTTOMRIGHT; |
| | } |
| Approaching, | locale = STA_LOCALE_HSPH; |
| leaving, | sublocale = SUBLOCALE_LEFT \| |
| neither a nor 1 | SUBLOCALE_RIGHT; if (angle < RIGHT_ANGLE) { |
| | sublocale = SUBLOCALE_FACING; |
| | } else if (angle > THREE_QUARTER_ANGLE) { |
| | sublocale = SUBLOCALE_FACING; |
| | } |
| Approaching, | locale = STA_LOCALE_HSPH; |
| neither a not 1, | sublocale = SUBLOCALE_LEFT \| SUBLOCALE_RIGHT; |
| approaching/ | if (num_routers > 2) { |
| leaving | switch (*tr_slope) { |
| | case STA_MVMT_APPROACHING: |
| | if (angle < STRAIGHT_ANGLE) |
| | sublocale = SUBLOCALE_LEFT; |
| | else |
| | sublocale = SUBLOCALE_RIGHT; |
| | break; |
| | case STA_MVMT_LEAVING: |
| | if (angle < STRAIGHT_ANGLE) |
| | sublocale = SUBLOCALE_RIGHT; |
| | else |
| | sublocale = SUBLOCALE_LEFT; |
| | break; |
| | case |
| | STA_MVMT_NEITHER_APPROACHING_NOR_LEAVING: |
| | default: |
| | break; |
| | } |
| | } |

FIG. 1B shows a block diagram illustrating how a user 150 may provide a number of parameters to a cloud application 154 using a user interface 152. The cloud application 154 may be configured to display AP placement to the user via user interface 152 on device 156. The user may position AP devices in a layout based on the placement provided by the user interface 152. When the AP devices are suitably positioned based on a placement diagram in the user interface, the AP devices and STAs (e.g., running a processing module) may be configured to provide metrics to an algorithm that is hosted on the same server as the cloud application or hosted locally on a STA or AP.

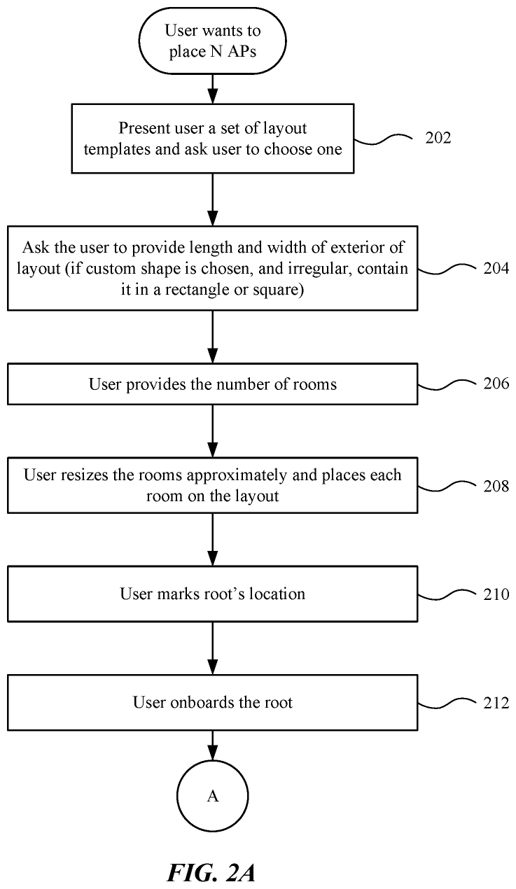

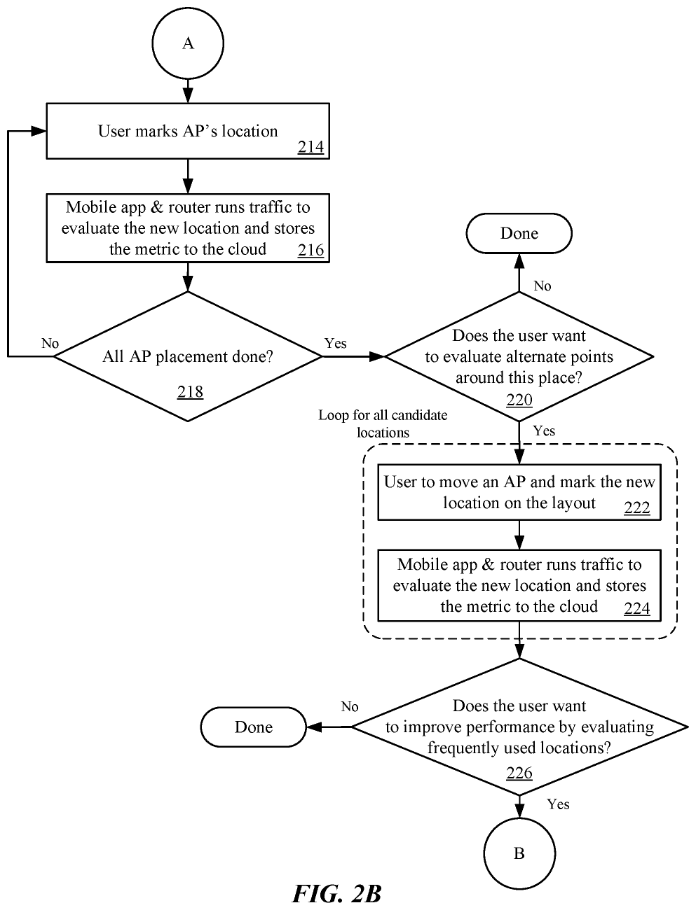

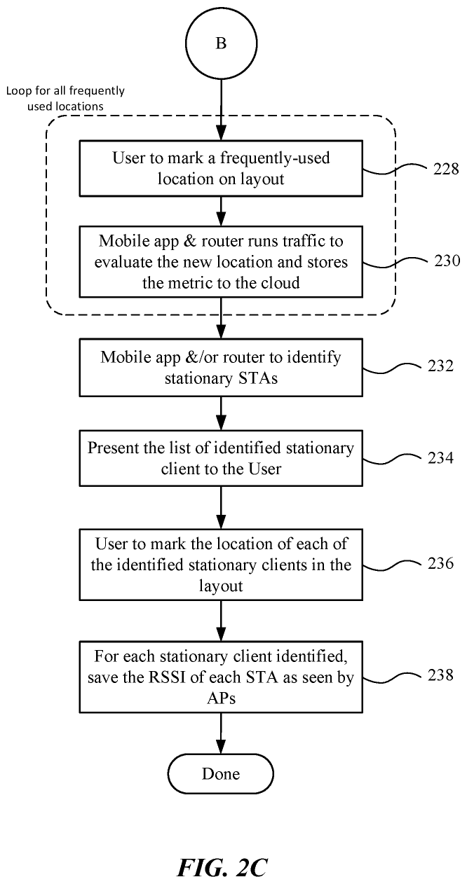

FIGS. 2A-2C show a series of inputs a user can make during onboarding of a Wi-Fi® mesh network having N APs. In particular, FIG. 2A shows how at 202 a user is presented a choice of layouts using pre-defined templates. The user can also be given the option to customize a selected pre-defined template. At 204, the user is asked for outer dimensions of the layout, such as length and width, which may define the outer boundaries of any square, rectangular, polygonal or elliptical shape established by the selected template. At 206, after defining the outer boundaries the user is asked how many rooms should be included in the template. At 208, the user is given the option to place and resize the rooms within the layout to make it correspond as closely as possible to property where the Wi-Fi® mesh network is going to be established. At 210, the user is asked to mark or identify the location of the root (i.e. wireless gateway). In an HFC network the root is generally the wireless or wired device attached directly to a coaxial cable and configured to interact with and process the DOCSIS signal delivered by the HFC network. At 212, the user is asked to initiate or onboard the root device so that the root can be registered and initiate communication with the HFC network.

FIG. 2B shows how at 214, the user is asked to mark a position of an APs within the selected and customized layout. In some embodiments, a user engaged with running the on-boarding can use one or more on-board sensors of a device being used for the onboarding to more accurately specify a location of the APs within the layout. For example, an on-device camera or LiDAR sensor can be used to confirm the location identified by the user. In scenarios where the sensor data conflicts with the positioning provided by the user, the user is asked if the position should be shifted to more closely align with readings taken by the device sensor. The user may also be asked to mark other locations relative to the AP placement that may be evaluated (e.g., power-outlet locations and/or the placement of stationary STAs.

At 216, tests are run to determine performance for the newly placed AP. In some embodiments, the performance tests include running traffic through the mesh network including its newly placed AP. The user can also be asked to walk around the property with the a device executing the STA finder and particularly walking in proximity to the newly placed AP in order to evaluate coverage of the newly placed AP subsequent to its movement. Evaluation of the coverage can involve identification of the STA zones and associated performance of the device within each identified STA zone as previously described. Results of the performance tests can be computed and collected by a cloud application or run on one or more local devices or alternatively processing can be split between local and associated cloud-based servers. 218 shows how steps 214 and 216 are repeated until all APs have been placed.

At 220, the user is asked if they wish to evaluate alternate points around the AP placements for potential performance improvements. In some embodiments, the user can be presented with one or more metrics indicating a level of performance achieved using the current AP placements. In the event the user is satisfied the process is completed. Otherwise the process continues to 222.

At 222, the user is given the option to move the respective APs to different locations on a property to see whether performance can be improved. For example, performance could suffer in the event APs are spread too far apart. In such a case movement of a first AP closer to a second AP could lead to a substantial improvement in performance. At 224, following movement of each AP additional traffic is run through the mesh network to evaluate performance of the newly moved AP.

In some embodiments, the current performance of the mesh Wi-Fi® network can be compared with what the STA finder processes deem to be a perfect or ideal performance level for a respective floor plan with a particular number of APs. However, when a user opts to add the location of the power outlets in the floor plan, the process may recalculate ideal performance levels AP locations in light of the power outlet locations. For example, the maximum coverage level for a router may differ when power outlets are not considered (e.g., the router may be placed in a maximum coverage location that does not have access to or requires an extension cord to reach a power outlet). When power outlets are considered, the maximum coverage location based on the power outlet locations may change to a location that provides a coverage level that is less than the coverage level without considering access to a power outlet.

At 228, a user can be asked to identify one or more frequently used locations on the floor plan/layout and at 230, evaluation processes can determine a performance of the mesh network within the identified frequently used location. At 232, once all the frequently used locations are identified and evaluated, the mobile application and/or router can be configured to identify one or more stationary clients operating on the mesh network. Identification of the stationary clients can be performed by referencing a list of devices known to require the use of a power outlet. For example, televisions, desktop computers, connected refrigerators and the like can be included in the list of stationary clients. Identification of the static STAs can also be performed by identifying STAs with changes in their RSSI values falling below a predetermined minimum threshold.

At 234, the list of identified stationary clients is sent to the user and at 236 the user can confirm each of the identified stationary clients is in fact a stationary client and then mark a location on the floor plan where each of the stationary clients is located. At 238, the RSSI for each STA as seen by the access points can be saved for future use, as will be discussed later, in situations where a STA operating on the wireless mesh network does not cross a CZ of an AP during a particular period of time. In some embodiments, the STA finder can be configured to make further AP repositioning recommendations based on performance of the stationary clients. For example, since the RSSI for each stationary client is recorded and generally is plugged into a power outlet, a stationary client having RSSI values below a desired threshold level may be a good location at which an AP can be positioned to improve performance of the wireless mesh network. In the scenario where a respective stationary client has RSSI readings high enough for another AP to repeat/extend the wireless mesh network, that stationary client location can be identified as a prospective location for a new AP or for movement of an existing AP to that location.

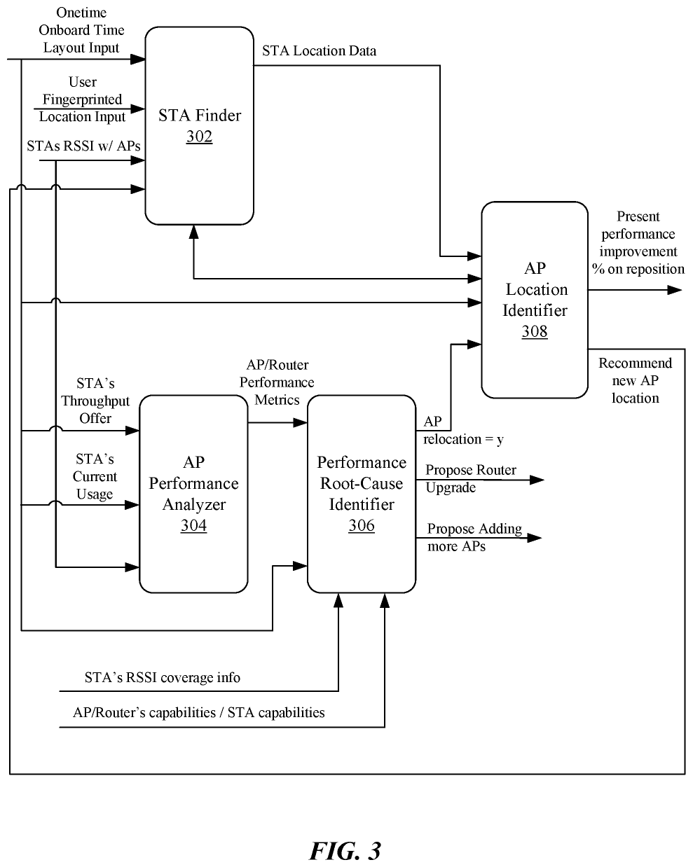

FIG. 3 shows how in some embodiments, at runtime, various parameters may be shared from the mobile application running on the device being used as a STA finder 302 to an algorithm that is hosted on the same server including: (i) a selected layout, (ii) layout dimensions, (iii) number of rooms, (iv) room placement (with their equivalent performance-metric), (v) rooms' size, (vi) number of routers, (vii) routers' location points, (viii) fingerprinted input (e.g., performance metrics, x, y coordinates, and router-id for each finger-print input and for each stationary client).

In some embodiments, at runtime, various parameters may be shared from the device to an algorithm that is hosted on the same server as the cloud application including: (i) received signal strength indicator (RSSI) of other APs during placement of each AP, and (ii) performance number to root (e.g., in Mbps) for each router placement.

In some embodiments, runtime parameters may be shared from the device to an algorithm that may be hosted on the same server as the cloud application and may be used in STA location identification. Each router in the network may send periodic feeds of STA RSSI for all the network STAs. This may be done by each router or AP running monitor mode to capture STA packets. The captured packets may be grouped into time-windows of 1 second each. One RSSI value may derived for a 1 second time-window and may be sent to STA finder module 302.

In some embodiments, the time-windows of bad AP/router performance may be shared from the primary AP/router for each of the connected to STAs to the cloud and may include: (i) each STA's budget served by the network, and (ii) each STA's usage as a percentage of the budget.

In some embodiments and as illustrated in FIG. 3, a processing device may be configured to identify an access point (AP) location using: (i) an AP performance analyzer 304, (ii) a performance root-cause identifier 306, (iii) STA finder 302, and (iv) an AP location identifier 308.

In some embodiments, AP performance analyzer 304 may be configured to provide AP performance metrics. In one example, AP performance analyzer 304 may also be configured to provide router performance metrics. The AP performance analyzer may be configured to receive the STA's throughput offer (e.g., the amount of throughput offered to the STA by the network) and the STA's current usage (e.g., the ratio, percentage, or amount of throughput offered to the STA by the network that is in use by the STA). AP performance analyzer 304 may be configured compute AP (e.g., router) performance metrics, which may be based on the STA's throughput offer and/or the STA's current usage, and output the AP (e.g., router) performance metrics to the performance root-cause identifier.

In some embodiments, performance root-cause identifier 306 may be configured to compute an AP relocation position. In one example, performance root-cause identifier 306 may be configured to compute a router relocation position when the AP is a router. Performance root-cause identifier 306 may be configured to receive the onboard time and layout as inputs. Performance root-cause identifier 306 may be configured to receive the AP (e.g., router) performance metrics from AP performance analyzer 304. Performance root-cause identifier 306 may be configured to compute an AP relocation position (e.g., a router or Wi-Fi® extender relocation position), a proposed router upgrade, and a proposed router addition. The performance root-cause identifier 306 may be configured to send the AP relocation position to AP location identifier 308.

In some embodiments, the AP location identifier may be configured to provide the AP relocation position to STA finder 302. In one example, when the AP location identifier provides a router location identifier, the router location identifier may be configured to provide the router relocation position to STA finder 302. In another example, AP location identifier 308 may be configured to compute the percentage increase in performance upon relocation, which may also be provided to STA finder 302 so that a user of STA finder 302 can make a more informed decision as to whether or not the performance increase justifies the relocation.

In some embodiments, STA finder 302 may be configured to compute a location of a STA. The STA finder may be configured to receive the onboard time, the layout input, the fingerprinted location input (one-time or periodically), or a STA's RSSI with respect to routers on a one-time basis or periodically. The STA may be configured, for each STA's location, to send various parameters to AP location identifier 308. The parameters may include: (i) the PRD, (ii) the SRD, (iii) the quadrant/hemisphere, (iv) the radius, or the (v) timestamp (ts).

In some embodiments, the STA finder may be configured to define a confidence zone (CZ) around each router. The size of the CZ may have a size that depends on the layout measurements of the property and/or technical specifics of a respective AP (e.g., a radius can be 5 m or 8 m). There may be two kinds of transitions involving the confidence zone: (i) out-to-in transition into CZ, and (ii) in-to-out transition from CZ. There may be one or more routers. A primary router, a secondary router, and a tertiary router may be defined based on a STA's RSSI with each of the routers in increasing distances. For example, the primary router may have a shorter distance from the STA compared to the secondary and tertiary routers, and the secondary router may be a longer distance from the STA compared to the primary router, but a shorter distance compared to the tertiary router. It should be noted that in some use cases a STA may be physically closer to the secondary router than the primary router due to obstructions present on a particular property causing RSSI variations.

In some embodiments, STA finder 302 may be configured to identify the STA zone. The STA zone may be computed based on one or more of: (i) PR, (ii) SR, (iii) TR, (iv) PRD, (v) SRD, (vi) TRD, (vii) quarter-sphere (viii) hemisphere, (ix) sphere (x) cylinder, (xi) tilt, (xii) radius, (xiii) confidence index, (xiv) ts, (xv) stamac.

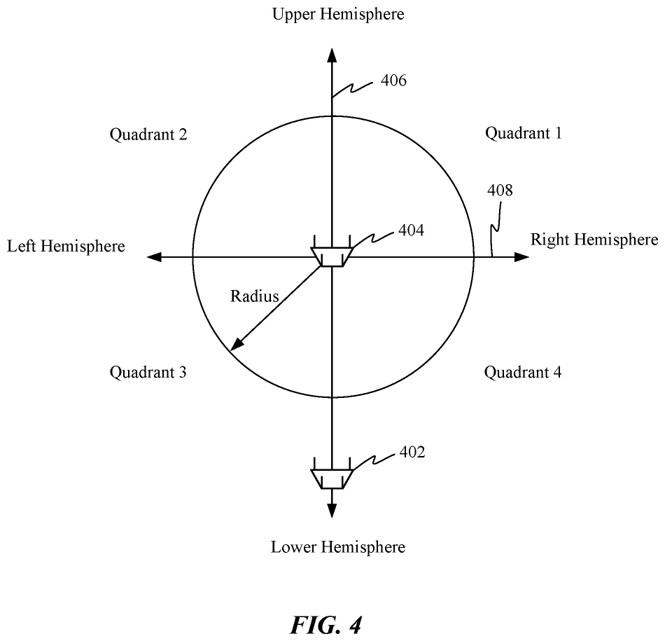

FIG. 4 shows how in some embodiments, the quarter-sphere or hemisphere may be defined by aligning a secondary router 402 directly below a primary router 404 as depicted such that a primary axis 406 extends through primary router 404 and secondary router 402 and a secondary axis 408 extends through primary router 404 in a direction orthogonal to primary axis 406. In this way, primary axis 406 and secondary axis 408 define a coordinate system defining multiple quadrants and hemispheres as indicated in FIG. 4.

In some embodiments, the STA finder may be subject to various constraints.

First, the STA finder may be configured to provide offline data computation, or periodic data computation (i.e., without using a real time locating system (RTLS)). Second, the location of the STA may have a maximum resolution of a quarter-sphere in embodiments where RSSI data is associated with three or fewer APs. Third, the location may be determined based on movement into or out of a confident zone. For example, the STA finder may be configured to track moving STAs without tracking stationary STAs. The STA finder may be configured to determine one or more back-in-time locations when a STA may cross into a confident zone of a router. Alternatively, or in addition, the STA finder may be configured to determine one or more forward in time locations when a STA may cross out of the confident zone of the router.

Fourth, the PRD, SRD, and TRD associated with each STA may be stored periodically using a timestamp. Fifth, a STA location algorithm may be triggered when an entry condition is satisfied. The entry condition may be satisfied when one or more of the distances between the STA and the router (e.g., PRD, SRD, TRD) is less than the confidence zone for the particular router. For example, for a STA-PRD confidence distance of 5 m, an STA-SRD confidence zone of 7 m, and a STA-TRD confidence zone of 10 m, an entry condition may be satisfied when the distance between the STA and the PRD is less than 5 m, or the distance between the STA and SRD is less than 7 m, or the distance between the STA and TRD is less than 10 m, or a combination thereof.

Sixth, for a STA that does not have a distance to a router that is less than a confidence zone, the STA may not be included in a STA location computation. It should be noted that this may not always be the case since RSSI readings for the STA can be correlated with historical RSSI readings for STAs that do cross the CZ to make determinations of position for the STA.

Seventh, the signal strength (e.g., RSSI) from one or more routers may be collected over time. The signal strength may be collected continuously or on a periodic basis (at an adequate resolution).

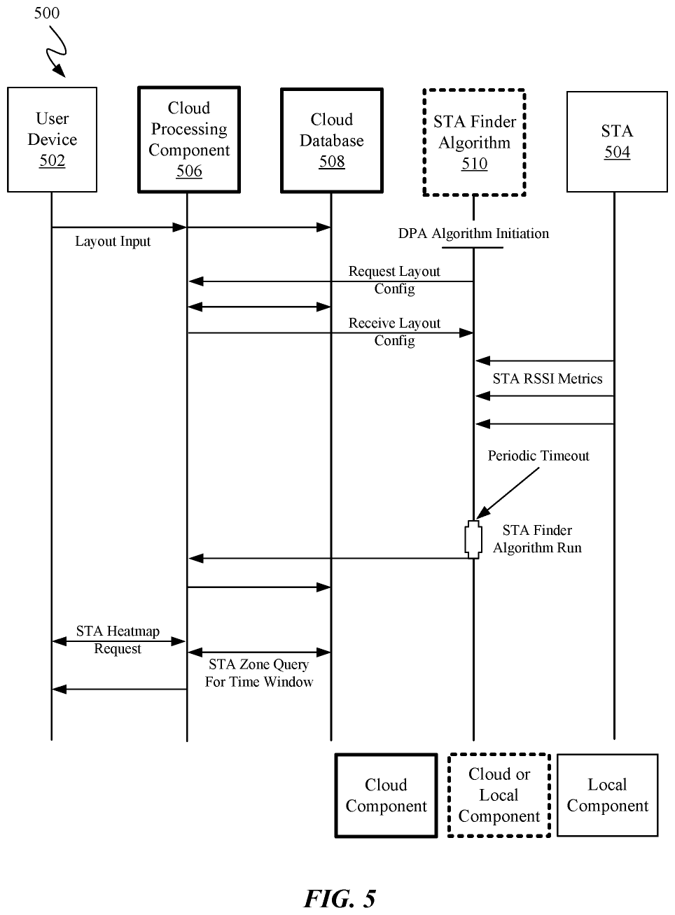

FIG. 5 illustrates a series of communications that can be performed by a STA finder architecture 500, when a STA satisfies an entry condition for a router for a first time in a particular movement of the STA (i.e., at a time defined as t₂), then a previous time (i.e., a time defined as t₁) may be computed.

FIG. 5 includes a first device (labeled as “user device 502”) that in some embodiments can take the form of a cellular or Wi-Fi® only device operating on a mesh network undergoing analysis or testing and being operated by a user of the STA finder. FIG. 5 also shows a block illustrating one or more local Wi-Fi® devices (e.g., a STA 504), and various cloud components (e.g., cloud processing component 506, a cloud database 508, and a STA finder algorithm 510. In some embodiments, STA finder algorithm 510 can take the form of a module running on a local device such as user device 502 and/or on one or more APs instead of on a cloud server. FIG. 5 shows several operations including one or more of: (i) sending, from user device 502 to cloud database 508 via cloud processing component 506, layout input, (ii) initiating, at STA finder algorithm 510, a dynamic placement assistance (DPA) algorithm, (iii) sending, from STA finder algorithm 510 to cloud processing component 506, a layout configuration request, (iv) communicating between cloud processing component 506 and cloud database 508 before a STA zone has been received by cloud processing component 506, (v) sending, from cloud processing component 506 to STA finder algorithm 510, the layout configuration, (vi) receiving, at STA finder algorithm 510 from STA 504, STA RSSI metrics, (vii) executing, at STA finder algorithm 510, the STA finder algorithm, (viii) send, from the STA finder algorithm module to the cloud processing component, a STA zone (e.g., STA MAC, zone parameters (PR, SR, locale, tilt, radius, STA, timestamp, or the like)); (ix) communicating between the cloud processing component and the cloud database after the STA zone has been received by the cloud processing component; (x) receiving, at the cloud processing component from user device 502, a STA heat map request (xi) receiving, at cloud processing component 506 from the cloud database, a query for a time window for the STA zone, or (xii) receiving, at user device 502 from cloud processing component 506, the STA heat map as computed based on the STA zone. The STA heat map generally shows how frequently a STA operates from various locations within a property.

In some embodiments, STA finder operations used to identify t₁ and t₂ for the STA's location may include one or more inputs as shown in Table (5) below, including: (a) STA RSSI time-series from the one or more routers (e.g., primary router, secondary router, tertiary router, and so forth), (b) the list of the routers and the location for each of the one or more routers, (c) the container name for each of the one or more routers.

TABLE 5
Input parameters

| Input name | Source |
|---|---|
| STA RSSI time series | device(fetch through cloud processing |
| from applicable routers | component) |
| Routers list and location | app(fetch through cloud processing |
| | component) |
| Router's container name | app(fetch through cloud processing |
| | component) |

In some embodiments, the STA finder operations used to identify t₁ and t₂ may output one or more STA coordinate sub-metrics which may include one or more zone parameters comprising: (primary router, secondary router, radius, epoch, zone, and orientation) as provided in Table (6) below.

TABLE 6
Output Parameters

| STA's coordinate | |
|---|---|
| sub-metric | unit |
| STA | MAC address |
| Primary router | String |
| Secondary router | String |
| Radius | Unsigned int |
| Epoch | Unsigned int |
| Zone | String - “sph” or “hsph” or “qsph” |
| Orientation | “towards”, “left”, “right”, “away” for “hsph”. |
| | “q1”, “q2”, “q3”, “q4” for “qsph” |

In some embodiments, a STA zone computation may be selected to proceed based on the operations as shown in the Table (7) below.

TABLE 7
STA Zone Computation Determination
Operation

STA finder operates periodically (e.g., every X seconds) to process
each STA's RSSI data
Identify a STA RSSI for which the STA RSSI changes > X dBm in a
selected time window.
Line fit the RSSI points of each STA-router pair.
For a particular STA-AP pair:
i. When STA-router RSSI does not indicate movement into an AP
confidence zone for which the router confidence zone is < CZ meters, then
the STA-AP RSSI points may not be used to compute a STA zone.
ii. When STA-router RSSI indicates movement into a router confidence
zone for which the router confidence zone is < CZ meters, then the
STA-AP RSSI points may be used to compute a STA zone

In some embodiments, when a STA zone computation has been selected to proceed, outside-in movement may be identified by the operations shown in Table (8) below.

TABLE 8
Inside-Out/Outside-In Identification
Operation

Identify a time t₂ when a STA moves across a CZ for the first time from
the start of the time window.
Based on the RSSI time series before and after t2, determine when the
movement during t₂ is: (i) inside the CZ to outside the CZ (i.e., when
RSSI is decreasing), (ii) outside the CZ to inside the CZ (i.e., when the
RSSI is increasing), (iii) movement within the CZ or movement entirely
outside of the CZ (the variation in RSSI fails to pass through a threshold).

In some embodiments, when a STA zone computation has been selected to proceed and Outside-In movement has been identified, a STA zone at a time t₁ may be computed based on the operations shown in Table (9) below. When Inside-Out movement is identified a STA zone at a time ts may be computed based on the operations shown in Table (9) below.

TABLE (9)
STA Zone Time t₁/t₃ Computation

```
Operation
Select t₂ as the first time the STA crosses the CZ and identify the PR, SR, TR, and so forth
as applicable.
Select the distance of the PR as the radius r₂ at time t₂ and the PR as the center point. This
distance generally corresponds to the radius of the CZ of the PR.
Identify a zone at t₂ as a circle with the radius r₂. The circle may be calculated by using the
SR's RSSI change.
Identify t₁ by calculating an RSSI for which the primary router changes from the current
primary router to a different primary router, or the RSSI indicates a change in movement
classification. The movement classification for the RSSI may be provided as shown in the
operations below:
  (A) For the PR (where the distance is within the CZ), identify time samples previous to
      time t₂.
  (B) For the time samples preceding (for Inside-Out) or subsequent (for Outside-In) to
      time t₂, divide the time samples into 4 quarter windows, 2 half windows, and 1 full
      window. For each of these 7 time-windows, calculate the angle θ of the slope using
      the following formula:
  (i)  calculate the slope, B, by solving the derivative of the least square error:
$B = \frac{n ( \sum xy ) - ( \sum x ) ( \sum y )}{n ( \sum {x}^{2} ) - ( \sum {x}^{2} )}$
where n is the number of samples, x is the time series, and y is the STA distance in meters.
The arctan of the slope (arctan (B)) provides the angle θ (with respect to the first quadrant
of the x axis) when θ has been normalized.
  (C) Classify the movement as:
      “approaching”,
      “leaving”,
      “neither approaching nor leaving.”
  (D) Calculate the earliest time point previous to t₂ in which the movement classification
      (as based on the slope) matches, and identify that time point as t₁.
```

In some embodiments, a radius at a time t₁ may be computed based on the operations shown in Table (10) below.

TABLE 10
Identifying Radius at time t₁

| | |
|---|---|
| 1. | Compute the number of APs/routers seeing a STA between times |
| | t₁ and t₂. |
| 2. | Label each of the APs as PR, SR, TR, and so forth in order of |
| | increasing distance. |
| 3. | Compute the PRD and select the PRD as the radius, R₁, at time, T₁. |

In some embodiments, after identifying PR_{T1}, SR_{T1}, TR_{T1} & PR_{T2}, SR_{T2}, TR_{T2} (SR_{T1} and SR_{T2} if SR is available, and TR_{T1} and TR_{T2} if TR is available), and determining that PR has not changed between T1 and T2, a STA zone at a time t₁ may be computed based on the following operations.

A first operation includes determining a distance from the STA to the PR (PRD at time T1), which is used as radius R₁. A second operation includes determining if a second AP/router (SR) is available. If SR is not available, the shape of the STA zone is a sphere with a radius R₁ and PR at the center. If depicted, the resulting STA zone would be donut shaped when seen from a top down view. In the case of a donut shaped STA zone, the thickness of the ring making the donut shape represent an uncertainty in the distance of the STA from the PR.

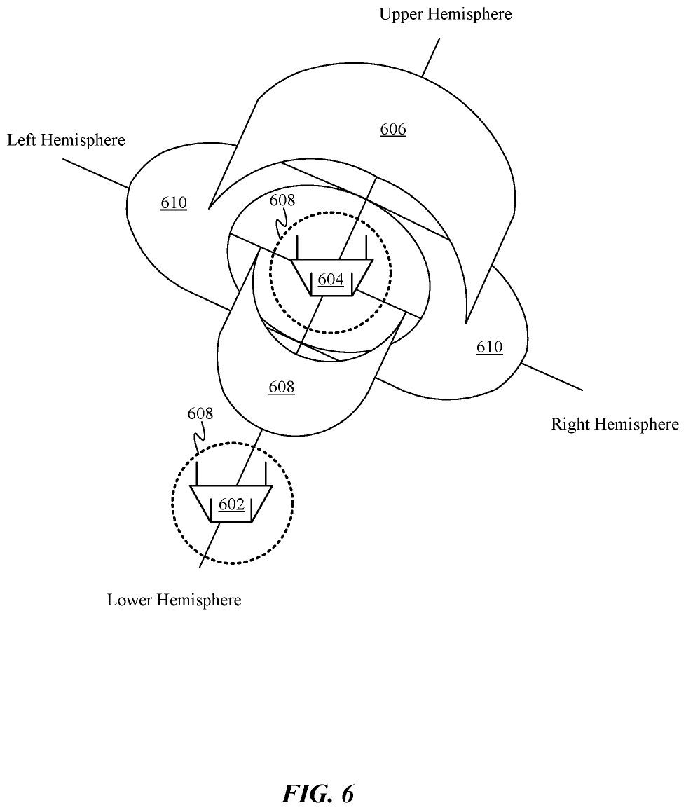

FIG. 6 shows multiple exemplary STA zones possible if at a time t₁ SR, identified in FIG. 6 as 602 is available (i.e. in communication with the STA) and RSSI values for PR are increasing. As depicted, the shape of each of the STA zones is a hemisphere of the sphere with radius R₁ and center point at PR, identified in FIG. 6 as 604. A first STA zone 606 is used when signal strengths from both PR 604 and SR 602 are increasing. This would be indicated by increases in RSSI from time T1 to time T2. While the term hemisphere is used to describe the shape of STA zone 606 it should be appreciated that STA zone 606 does not represent an entire hemisphere of the sphere defined by the center of PR 604 and radius R1. Instead there is a gap between STA zone 606 and a CZ 608 surrounding 604. A size of the gap can depend on a duration of time between T1 and T2 and a rate of change of the RSSI values, which can be correlated with a distance between the outer boundary of STA zone 606 and CZ 608. It should also be noted that the peripheral ends of the hemispherical shape making up STA zone 606 located near the left and right hemisphere labels are shorter than a true hemisphere as a location of the STA in these positions at T1 would not allow for a sufficient amount of movement toward SR 602 to constitute an increasing RSSI value for SR 602.

A second STA zone 608 can be used when received signal strength for PR 604 is increasing and received signal strength for SR 602 is decreasing. As depicted, an overall size of STA zone 608 is substantially smaller than that of STA zone 606 since the differential RSSI values allow the algorithm to make a more precise determination of the position of the STA relative to PR 604 and SR 602.

A third STA zone 610, positioned on opposing sides of PR 604, can be used when received signal strength for PR 604 is increasing and received signal strength for SR 602 is remaining substantially static. In some embodiments, substantially static can mean RSSI values do not vary by more than a threshold amount from an average of the RSSI values for a particular period of time. For example, the threshold amount could be a variance of 5%, 10% or 15% from the average of the RSSI values for the particular period of time. While the exemplary STA zones help to describe operation of the STA finder, it should be appreciated that the size and geometry of the STA zones can vary somewhat based on the magnitude and rate of change of the RSSI values as will be evident in the variations shown in the various examples provided below.

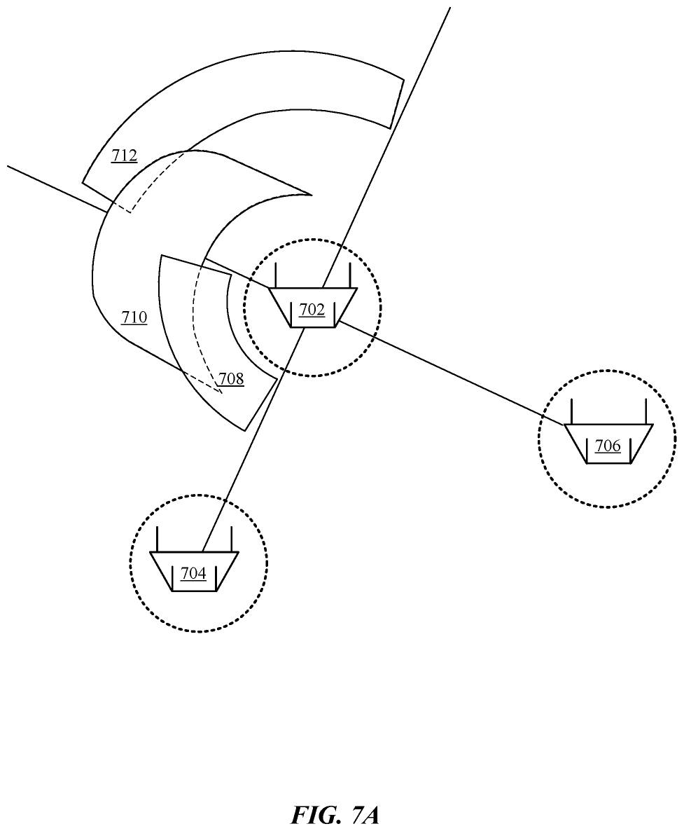

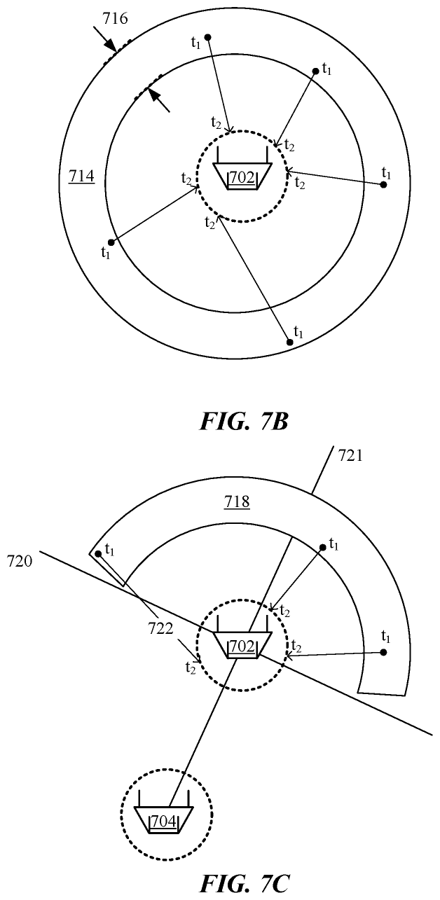

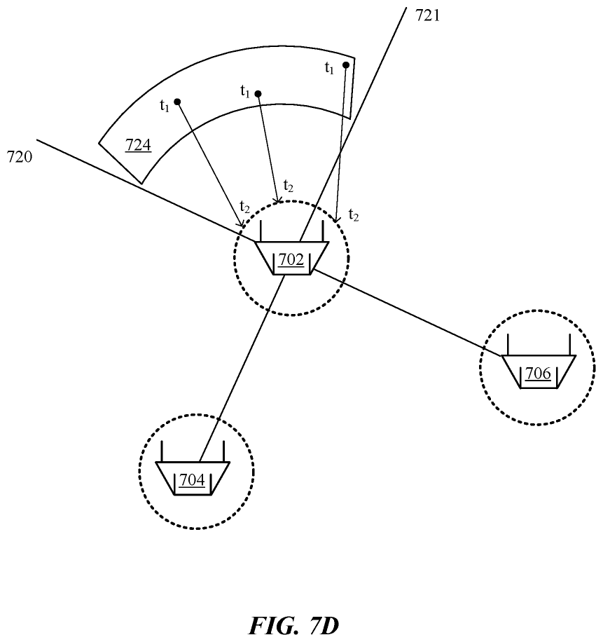

FIG. 7A shows multiple exemplary STA zones possible for the depicted configuration of three available APs, where AP 702 is the PR, AP 704 is the SR and AP 706 is the TR. Each of the depicted STA zones 708, 710 and 712 correspond to a scenario in which RSSI values for AP 702 and AP 706 are detected to be increasing. STA zone 708 represents possible locations of a STA at T1 with increasing RSSI values for APs 702 and 706 and decreasing RSSI values for AP 704. STA zone 710 represents possible locations of a STA at T1 with increasing RSSI values for APs 702 and 706 and substantially static RSSI values for AP 704. STA zone 712 represents possible locations of a STA at T1 with increasing RSSI values for APs 702 and 706 and decreasing RSSI values for AP 704.

FIGS. 7B-7D show a step by step method for identifying STA zone 712 from FIG. 7A. In particular, FIG. 7B shows how RSSI values can be used to estimate a STA zone 714 for a STA based only upon RSSI values from a single AP 702. STA zone 714 is depicted with an annulus geometry in two dimensions or a torus/donut-shaped geometry if viewed in three dimensions. Multiple arrows marked with t₁ and t₂ markings are included to show the large number of movements that could be indicated when only considering increasing RSSI values for AP 702. A thickness 716 of STA zone 716 can be based on an uncertainty of the distance between measurements provided by the RSSI values at time t₁. For example, a distance calculation for lower RSSI values indicating longer distances can be less certain than a distance calculation for higher RSSI values indicating shorter distances from a respective AP/router.

FIG. 7C shows how when RSSI values are considered from AP 702 and AP 704 an area/size of resulting STA zone 718 is much smaller than the area of STA zone 714. STA zone 718 can be referred to as hemispherical in shape, however it should be appreciated that it generally does not extend entirely to secondary axis 720 and through primary axis 721. STA zone 718 does not include the area between STA zone 718 and axis 720 because if the STA were located in this area, the magnitude of RSSI increase for AP 704 would not be great enough to consider it as an increase. For example, exemplary movement indicator 722 shows an edge case where t₁ is near the edge of STA zone 718, such that as any more movement of t₁ of movement indicator 722 toward axis 720 would result in the t₂ end of movement indicator 722 not hitting the CZ of AP 720 or the slope adjusted in a way that results in little to no movement of the STA toward AP 704.

FIG. 7D shows how when RSSI values are considered from AP 702, AP 704 and AP 706 an area/size of resulting STA zone 724 is much smaller than the area of STA zone 718. As with STA zone 718 the ends of STA zone 724 do not reach axes 720 or 721. However, in embodiments where the STA zone is closer to the CZ of AP 702 there may be cases where STA zone does reach or extends slightly past axes 720 and 721. In some implementations, STA zone 724 can be represented as moving entirely to axes 720 and 721 to reduce the amount of processing power to exclude peripheral ends of a respective STA zone.

FIG. 8 shows multiple exemplary STA zones possible for the depicted configuration of three available APs, where AP 802 is the PR, AP 804 is the SR and AP 806 is the TR. Each of the depicted STA zones 808, 810 and 812 correspond to a scenario in which RSSI values for AP 802 are detected to be increasing and RSSI values for AP 706 are detected to be decreasing. STA zone 808 represents possible locations of a STA at T1 with increasing RSSI values for APs 802 and decreasing RSSI values for AP 804 and AP 806. STA zone 810 represents possible locations of a STA at T1 with increasing RSSI values for APs 802 and 806 and substantially static RSSI values for AP 804. STA zone 812 represents possible locations of a STA at T1 with increasing RSSI values for APs 802 and 804 and decreasing RSSI values for AP 806.

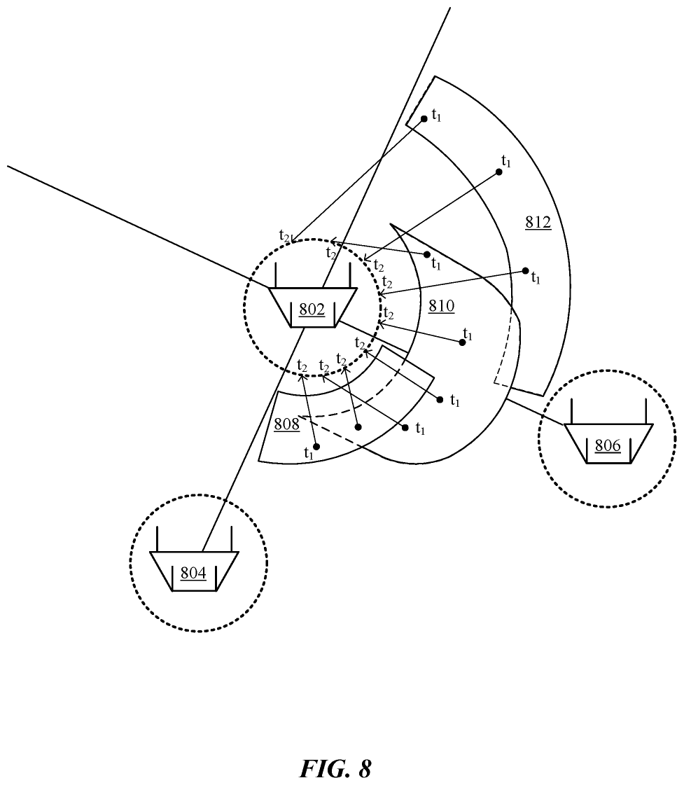

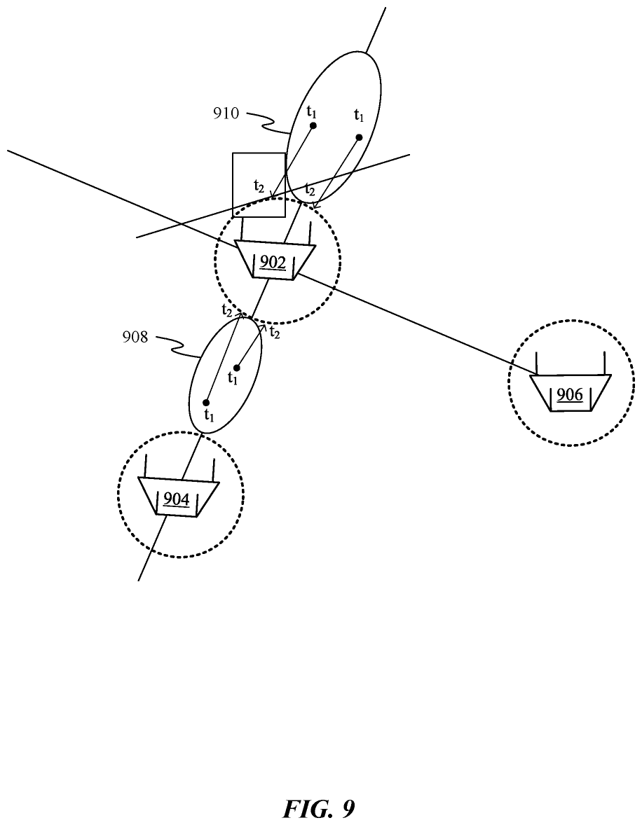

FIG. 9 shows multiple exemplary STA zones possible for the depicted configuration of three available APs, where AP 902 is the PR, AP 904 is the SR and AP 906 is the TR. Each of the depicted STA zones 908 and 910 correspond to a scenario in which RSSI values for AP 902 are detected to be increasing and RSSI values for AP 906 are detected to be remaining substantially static. While most AP diagrams depicted in this paper show three different STA zones, this particular configuration results in only two STA zones 908 and 910 since defining a third STA zone in which RSSI values are static for both APs 904 and 906 is less useful given the 90 degree offset between APs 904 and 906 as the zone would have a circular geometry and wouldn't narrow down a location of a respective STA very accurately. STA zones 908 and 910 are particularly small as depicted due to them being limited in size for scenarios in which RSSI values for AP 906 remaining static. AP 908 is particularly well bounded in size due to its location between APs 902 and 904. In some embodiments, when static RSSI values are detected for APs 904 and 906, the corresponding data will be discarded as an outlier or as data that doesn't correspond to a usefully limited zone relative to the PR.

In some embodiments, after identifying PR_{T1}, SR_{T1}, TR_{T1} & PR_{T2}, SR_{T2}, TR_{T2} (SR_{T1} and SR_{T2} if SR is available, and TR_{T1} and TR_{T2} if TR is available), and determining that PR has changed between T1 and T2, a zone at a time t₁ may be computed as described below and illustrated in the associated figures.

FIG. 10 shows multiple exemplary STA zones possible for the depicted configuration of two available APs, where AP 1002 is the PR and AP 1004 is the SR at time t₂ while AP 1004 is the PR and AP 1002 is the SR at time t₁. Each of the depicted STA zones 1008, 1010 and 1012 correspond to a scenario in which RSSI values for AP 1002 are detected to be increasing. FIG. 10 can be compared with FIG. 6 and differs primarily in the location of STA zone 1012. STA zone 1006 represents possible locations of a STA at t₁ with increasing RSSI values for AP 1002 and decreasing RSSI values for AP 1004. STA zone 1008 represents possible locations of a STA at time t₁ with increasing RSSI values for AP 1002 and 1004. STA zone 1010 represents possible locations of a STA at time t₁ with increasing RSSI values for AP 1002 and static RSSI values for AP 1004. STA zone 1010 is centered on the location of AP 1004 due to the PR being AP 1004 at time t₁. While the location of the STA zones is primarily based on changes in RSSI at the various APs, the PR at time t₁ is also factored in and particularly for the STA zone, similar to STA zone 1010 in which the RSSI values for the PR are at t₁ are staying substantially static from time t₁ to time t₂.

FIG. 11 shows multiple exemplary STA zones possible for the depicted configuration of three available APs, where AP 1102 is the PR, AP 1104 is the SR and AP 1106 is the TR at time t₂. At time t₁, AP 1102 is the SR, AP 1104 is the PR and AP 1106 is the TR. Each of the depicted STA zones 1108, 1110 and 1112 correspond to a scenario in which RSSI values for AP 1102 and 1106 are detected to be increasing. STA zone 1108 corresponds to increasing RSSI values for AP 1104. STA zone 1110 corresponds to decreasing RSS values for AP 1104 and STA zone 1112 corresponds to substantially static values for AP 1104. It should be noted that the t₁ end of the movement indicators associated with STA zone 1108 clearly indicate the STA as being closer to AP 1102 than AP 1104 at time t₁. Generally speaking and as discussed previously, changes in RSSI values are prioritized over, which AP has the strongest signal at time t₁. Consequently, STA zone 1108 is correctly positioned regardless of the PR at time t₁ being AP 1104. A situation like this might occur when a STA remains connected to a particular AP or router after it's no longer in the closest proximity to the particular AP or router or as a result of environmental obstacles reducing the received signal strength of a particular router or AP. In some embodiments, the STA finder device can be configured to ignore or deprecate RSSI change parameters that jumps almost immediately at a speed that is more likely to indicate the RSSI change is due to clearing or entering a zone where RSSI signal strength is dramatically higher or lower than the rest of a property hosting the mesh Wi-Fi® network.

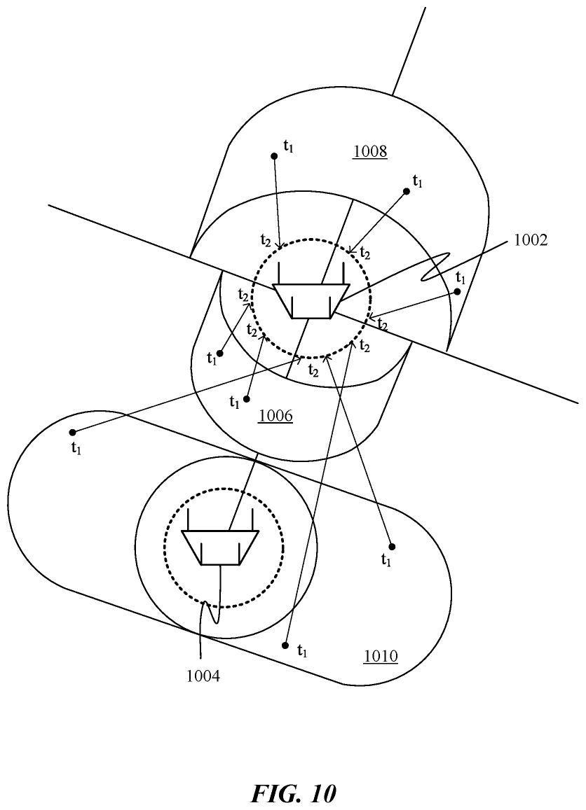

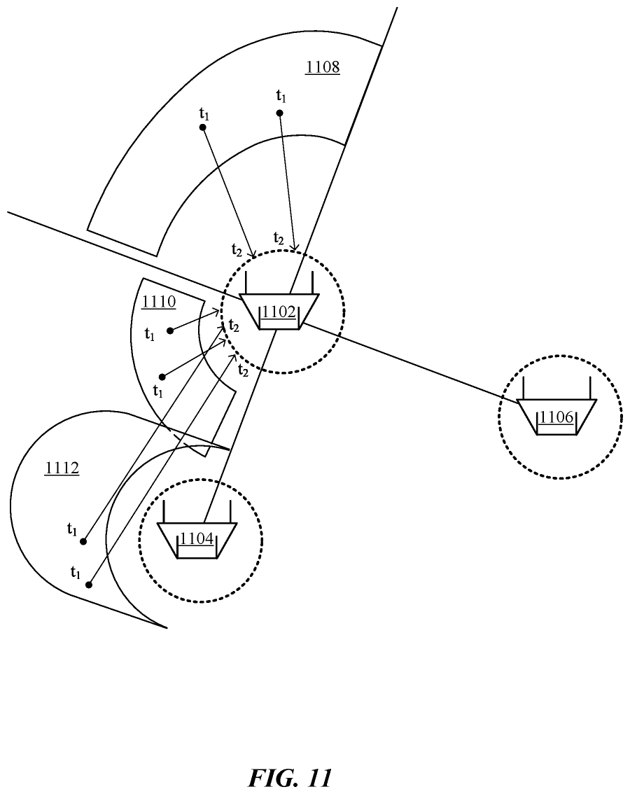

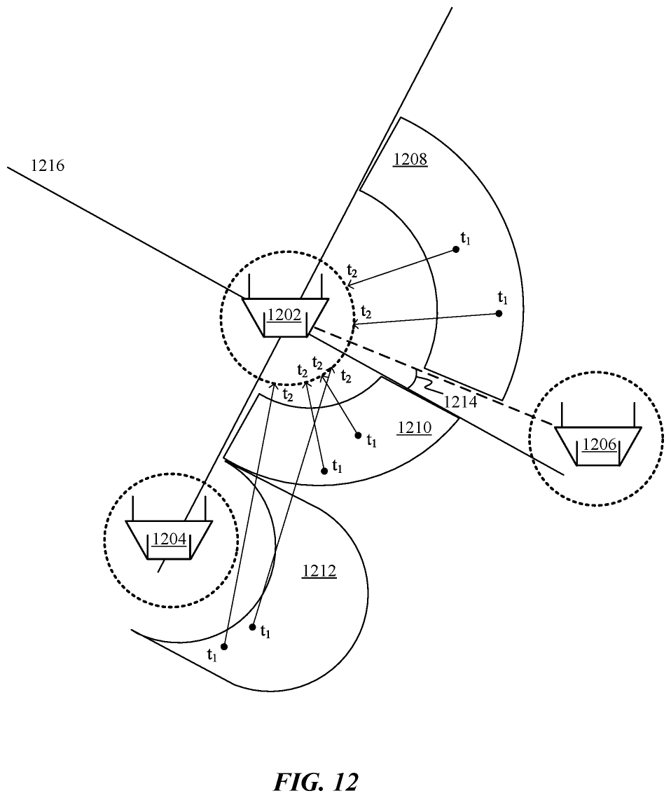

FIG. 12 shows multiple exemplary STA zones possible for the depicted configuration of three available APs, where AP 1202 is the PR, AP 1204 is the SR and AP 1206 is the TR at time t₂. At time t₁, AP 1202 is the SR, AP 1204 is the PR and AP 1206 is the TR. Each of the depicted STA zones 1208, 1210 and 1212 correspond to a scenario in which RSSI values for AP 1202 are increasing and RSSI values for AP 1206 are detected to be decreasing. STA zone 1208 corresponds to increasing RSSI values for AP 1204. STA zone 1210 corresponds to decreasing RSS values for AP 1204 and STA zone 1212 corresponds to substantially static values for AP 1204. The configuration of APs shown in FIG. 12 also show a slightly different configuration of routers. In particular, AP 1206 is radially offset from AP 1204 by over 90 degrees instead of exactly 90 degrees as shown in previous illustrations. Angle 1214 shows the angular offset between AP 1206 and primary axis 1216. As depicted, STA zone 1208 remains close to a quarter sphere in size with an offset from axis 1216 that corresponds to keeping movement toward AP 1204 when a STA moves from the side of STA zone 1208 closest to axis 1216 to the CZ of AP 1202.

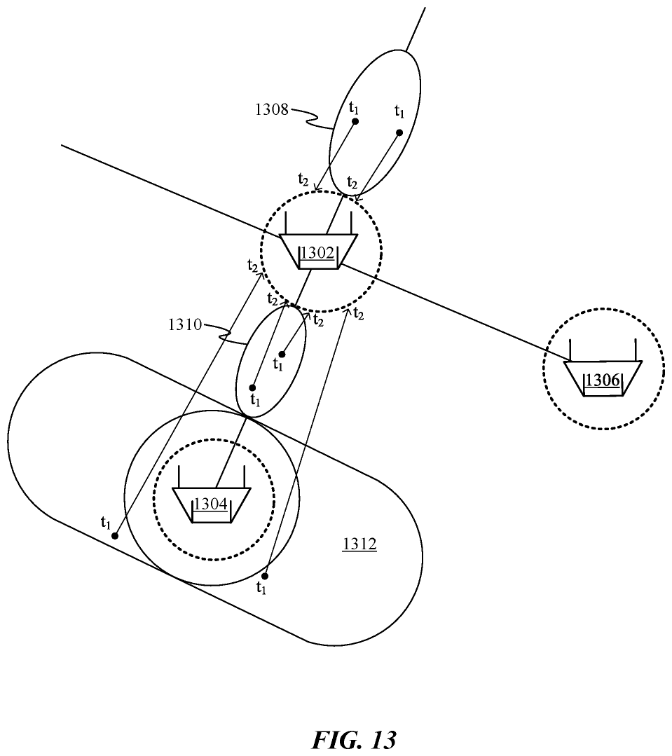

FIG. 13 shows multiple exemplary STA zones possible for the depicted configuration of three available APs, where AP 1302 is the PR, AP 1304 is the SR and AP 1306 is the TR at time t₂. At time t₁, AP 1302 is the SR, AP 1304 is the PR and AP 1306 is the TR. Each of the depicted STA zones 1308, 1310 and 1312 correspond to a scenario in which RSSI values for AP 1302 are increasing and RSSI values for AP 1306 are detected to be remaining substantially static. STA zone 1308 corresponds to increasing RSSI values for AP 1304. STA zone 1310 corresponds to decreasing RSSI values for AP 1304 and STA zone 1312 corresponds to substantially static values for AP 1304. The movement indicators for STA zone 1312 are arranged tangentially with respect to the CZ for AP 1304. In this way, the movement indicators for STA zone 1312 show possible STA movements resulting in substantially static RSSI values for both AP 1304 and AP 1306.

It should be noted that while the movement indicators associated with FIGS. 7A-13 all show outside in movement that the STA aforementioned STA zones can also be used to describe inside out movement. In particular, when inside out movement is detected at time t₂, instead of analyzing recent historical data to determine a position of the STA at time t₁ analysis is instead performed to determine a location of the STA at time t₃, which occurs subsequent to time t₂. Time t₃ can be determined in a similar way as time t₁ was previously described using the least square error equation Eq (1) to determine how long the STA moves in a linear direction away from the CZ of the PR. In some embodiments, following detection of a STA crossing the CZ of the PR and moving linearly away from the PR a sampling rate of RSSI data can be increased to more precisely identify a position of the STA at time t₁ and to accurately identify the time t₁. It should be noted that movement indicators for inside out movement could be made applicable to FIGS. 7B-13 by reversing the direction of the arrows, marking the beginning of the arrow as t₂ and the end of the arrow within the STA zone as t₃.

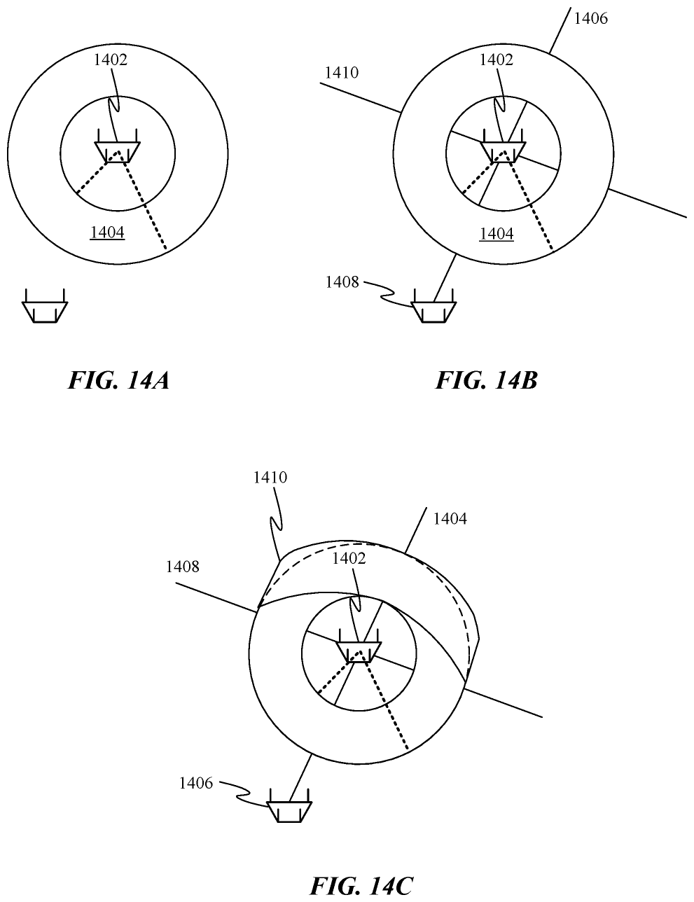

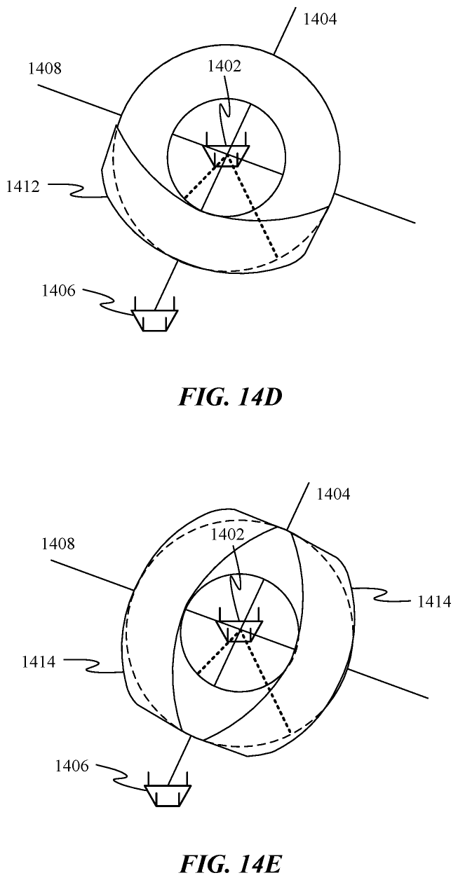

FIGS. 14A-14E shows another exemplary method for approximating the size and arrangement of STA zones relative to multiple APs. FIG. 14A shows a first step in which two concentric circles are drawn around AP 1402 designated as the PR to form a spherical STA zone 1404. Since RSSI values do not provide a precise distance between a STA and an AP, the radii of the two circles can represent two distances from AP 1402 at time t₁ that accommodate the lack of accuracy in the distance measurement based on RSSI values from AP 1402 alone. The shorter distance will always be equal to or greater than the CZ for STA 1402. In one exemplary embodiment, the radius of the smaller circle can be 8 m and the radius of the larger circle can be 16 m. FIG. 14B shows how a first axis 1404 can be drawn from AP 1402 to AP 1404, where AP 1406 is the SR and how a second axis 1408 can be drawn through AP 1402 at an angle orthogonal to the angle of first axis 1404.

FIGS. 14C-14E show how to define STA zones for various changes in RSSI values for a two AP configuration. In particular, FIG. 14C shows how a hemi-spherically shaped STA zone 1410 can be drawn on a side of AP 1402 opposite the position of AP 1406 with increasing RSSI values for both AP 1402 and AP 1406. FIG. 14D shows how a hemi-spherically shaped STA zone 1412 can be drawn on the same side of AP 1402 as AP 1406 for increasing RSSI values for AP 1402 and decreasing values for AP 1406. FIG. 14E shows a STA zone 1414, made up of two hemi-spherically shaped areas on opposing sides of AP 1402, for increasing RSSI values of AP 1402 and substantially static values of AP 1406. The orientation of hemi-spherically shaped areas of STA zone 1414 are arranged on sides of AP 1402 orthogonal to AP 1406.

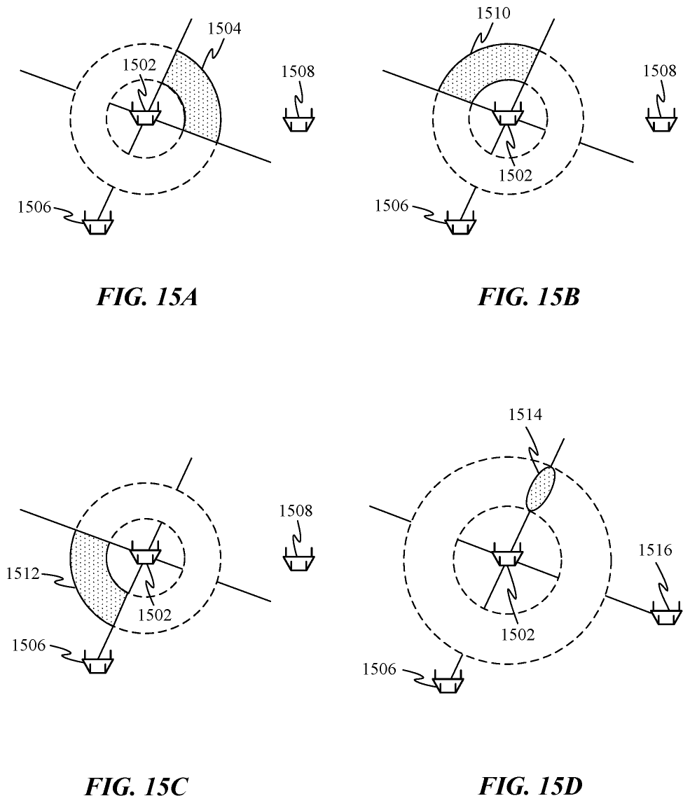

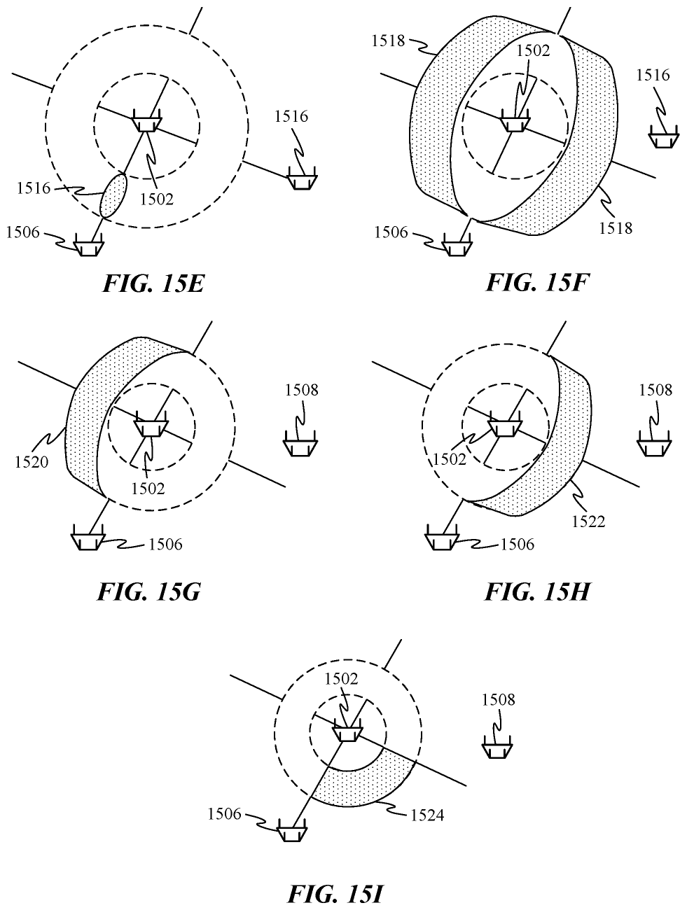

FIGS. 15A-15I show how STA zones can be selected relative to a spherical outline (an annulus shape in two dimensions as depicted) surrounding AP 1502 with inner and outer radii based on RSSI values for AP 1502 for three AP configurations. For each of the STA zones discussed in FIGS. 15A-15I AP 1502 is designated as the primary router and AP 1506 is designated as the secondary router. FIG. 15A shows a STA zone 1504 that corresponds to the depicted configuration of APs 1502, 1506 and 1508 with increasing RSSI values for AP 1502 and AP 1506 and decreasing RSSI values for AP 1508. It should be noted that AP 1508 is not located on the secondary axis defined by the relative positions of APs 1502 and 1506 making it slightly different than most of the other exemplary AP configuration diagrams previously described. While STA zone 1504 has a quarter spherical geometry, a more complex STA zone modeling scheme could shave off some of the periphery of STA zone 1504 based on the offset position of AP 1508 to make it smaller/more precise. However, the quarter spherical geometry is large enough to cover the possible positions of a STA moving from STA zone 1508 to a point on a CZ of AP 1502 with the detected changes in RSSI values for the depicted configuration of access points and requires less processing power to determine its size and shape.

FIG. 15B shows a STA zone 1510 that corresponds to the depicted configuration of APs 1502, 1506 and 1508 in which RSSI values for AP 1502, AP 1506 and AP 1508 are increasing. FIG. 15C shows a STA zone 1512 that corresponds to the depicted configuration of APs 1502, 1506 and 1508 in which RSSI values for AP 1502 and AP 1508 are increasing and RSSI values for AP 1506 are decreasing. FIG. 15D shows an elliptically shaped STA zone 1514 that corresponds to the depicted configuration of APs 1502, 1506 and 1516. STA zone 1514 is based on RSSI values for AP 1402 and AP 1406 increasing with RSSI values for AP 1426 remaining substantially static. STA zone 1424 is depicted with an elliptically shaped geometry that fits between the inner and outer diameters of the dashed annulus shape.

FIG. 15E shows a STA zone 1510 that corresponds to the depicted configuration of APs 1502, 1506 and 1508 in which RSSI values for AP 1502, AP 1506 and AP 1508 are increasing. FIG. 15C shows a STA zone 1512 that corresponds to the depicted configuration of APs 1502, 1506 and 1508 in which RSSI values for AP 1502 and AP 1508 are increasing and RSSI values for AP 1506 are decreasing. FIG. 15D shows an elliptically shaped STA zone 1514 that corresponds to the depicted configuration of APs 1502, 1506 and 1516. STA zone 1514 is based on RSSI values for AP 1502 increasing, RSSI values for AP 1406 decreasing and with RSSI values for AP 1516 remaining substantially static. The elliptically shaped geometry of STA zone 1514 fits between the inner and outer diameters of the dashed annulus shape.

FIG. 15E shows an elliptically shaped STA zone 1516 similar to the one shown in FIG. 15D and is based on RSSI values for AP 1502 and AP 1506 increasing with RSSI values for AP 1516 remaining substantially static. FIG. 15F shows a hemi-spherically shaped STA zones 1518 on opposing sides of AP 1502 corresponding to the left and right hemispheres as described previously in relation to FIG. 4. STA zones 1518 correspond to RSSI values for AP 1502 increasing while RSSI values for AP 1506 and AP 1516 staying substantially static. It should be noted that the area from which a STA can approach AP 1502 without substantial changes in APs 1506 and 1516 would generally be much smaller than depicted. STA zones 1518 are provided to help with reducing computational processing and correspond more closely to a two router configuration in which RSSI values are increasing for AP 1502 and staying substantially static for AP 1506. Adding in substantially static values for AP 1516 makes the frequency of these RSSI readings relatively small in frequency since most movement toward AP 1502 and ending at its CZ would result in some change for either or both of AP 1506 and 1516. However, this zone can be useful in limited instances of short distances of travel or where some obstacle to RF travel causes static RSSI values for APs 1506 and 1516.

FIG. 15G shows a hemi-spherically shaped STA zone 1520 and is based on RSSI values for AP 1502 and AP 1508 increasing while RSSI values for AP 1506 are staying substantially static. FIG. 15H shows a hemi-spherically shaped STA zone 1522 located in the right hemisphere and is based on RSSI values for AP 1502 increasing, RSSI values for AP 1508 decreasing and RSSI values for AP 1506 staying substantially static. FIG. 15I shows a quarter-sphere shaped STA zone 1524 located in quadrant 4 as depicted and is based on RSSI values for AP 1502 increasing and RSSI values for AP 1506 and AP 1508 decreasing.

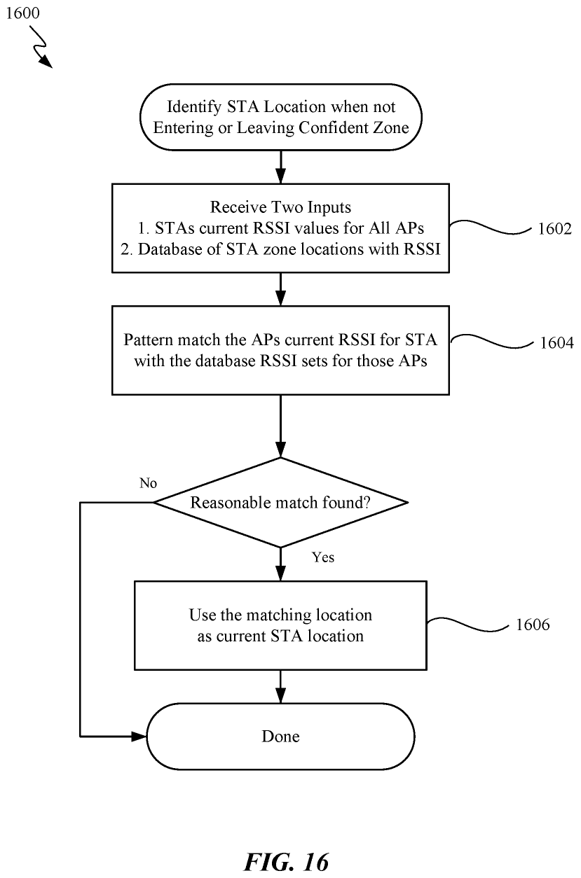

FIG. 16 shows a flow chart 1600 describing a method performed by the STA finder when a particular STA or a STA hosting the STA finder does not enter into or exit a CZ of an access point during a period of time during which RSSI data is collected. The method described by flow chart 1600 can be used to determine a location of the STA and a confidence index. The location of the STA may be associated with a particular confidence index by using one or more different pattern matching computations. In some embodiments, when a particular STA does not enter or exit a CZ during the period of time, current RSSI values and/or changes in RSSI values for the STA can be analyzed/pattern matched at multiple different times over the period of time in order to find a time or times with RSSI values that match closely with locations/zones in a historical database of STA locations. In some embodiments, only times in which poor wireless performance is experienced can be analyzed/pattern matched.

Block 1602 of FIG. 16 shows how the two inputs for a pattern matching computation may include: (i) the STA's current RSSI values for each associated access point, and (ii) a database of STA locations associated with RSSI values for the respective STA locations. At 1604 the access points' current RSSI values may be pattern matched with the database RSSI values for those access points of the wireless mesh network in communication with the STA. It should be noted that a STA may not be perpetually in communication with or sensed by all access points within a mesh network. This can be particularly true for larger wireless mesh networks.

Current RSSI values refers to the RSSI values at a particular instant in time. In limited instances, current RSSI values can also refer to a current rate of change of the RSSI values at the particular instant in time, however this data is generally used sparingly as the rates of change tend to be more transient in nature and consequently less consistent than RSSI values averaged over short periods of time. When rate of change data is used, it can be determined by monitoring RSSI changes during a period of time before and/or after the particular instant in time. Rate of change information can provide additional correlation data points when RSSI change data is stored in the database of STA locations. When a suitable match in RSSI is identified between the database RSSI values and the AP RSSI values, the database RSSI values (e.g., associated with a particular STA location) may be used in matching the PRD, SRD, TRD with the associated database values (e.g., PR, SR, TR, PRD, SRD, TRD, quarter-sphere, hemisphere, radius, and the like) with the STA's PRD, SRD, and TRD. A suitable match is generally determined by identifying a previously defined STA zone with the closest RSSI values to the AP RSSI values for the STA. However, a closeness of the RSSI values for the PR are weighted more heavily than RSSI values for the SR, which are in turn weighted more heavily than RSSI values for the TR. For example, a previous first STA zone with closer SR and TR values can be determined a worse match than a previous second STA zone with closer PR values but with less close SR and TR values than the first STA zone. In some embodiments and particularly in use cases in which large numbers of previous STA zones are available to sample from a top two or three STA zones can be identified and then matched to provide a more refined location for the STA.

At 1606, when the match between the quarter-sphere, hemisphere, and radius values is suitable, then the quarter-sphere, hemisphere, and radius values may be used to determine a current location and/or zone for the STA. In the event no reasonable match is found the process can be repeated for a different STA or for the same STA at a different time.

In some embodiments, after the routers have been re-positioned in accordance with the router location identifier, the STA finder may be configured to provide STA locations to the router location identifier and the router performance analyzer may be configured to provide router performance metrics (based on the repositioned router locations) to the performance root-cause identifier for processing and the sending of router location data to the router location identifier. The router location identifier may be configured to further process the router performance metrics after the reposition and provide a graphical display illustrating the differences in performance before and after router repositioning.

### Mobile App:

In some embodiments, a STA finder system may include: a mobile app (e.g., a CMA (Cloud Mobile App), an RSSI monitor (e.g., an RSSI Monitor daemon on a device), a STA finder module (e.g., running as part of a processing module on a device), a server (e.g., CBS Cloud Backend Service), and a user equipment (e.g., operated by a user).

In some embodiments, the scope of the STA finder system may include: (i) finding a STA zone for STAs moving towards or away from a router/AP (e.g., zone shapes such as a circle, hemisphere, quarter-sphere, and cylinder), and (ii) finding tilt to represent the direction.

In some embodiments, the input from the user equipment may include: (i) choose a floor map, (ii) basic floor configuration, and (iii) router's location.

In some embodiments, the output may include a heat map of STA zones displayed on the mobile app for the selected time interval.

In some embodiments, the mobile app may have the following features: (a) during on-boarding, floor map templates may be displayed on a STA or UE with at least one floor map template being selected by the UE; (b) during on-boarding, some fields of the floor may be edited on the UE; (c) during on-boarding, routers may be placed on the floor map using the UE, and (d) during runtime, a heat-map of STA access may be used internally to verify functionality. In some embodiments, the backend server may have the following features: (i) During on-boarding, the mobile app may write the layout configuration to the backend server; (ii) during runtime, the device may pull the layout configuration from the backend server; (iii) during runtime, the device may send the STA zone to the backend server; (iv) during runtime, the mobile app may pull STA zone details from the backend server to build the heat-map.

In some embodiments, the RSSI monitor may have the following features: (a) the RSSI Monitor may operate on the device, (b) the RSSI monitor may collect all network's STAs' RSSI and periodically send a report to the STA finder, (c) the RSSI monitor may use a Block ACK control frame transmitted by the STAs.

In some embodiments, the STA finder may be configured as disclosed herein, including: a STA finder module, a router performance analyser module, a performance root-cause identifier module, and a router location identifier.

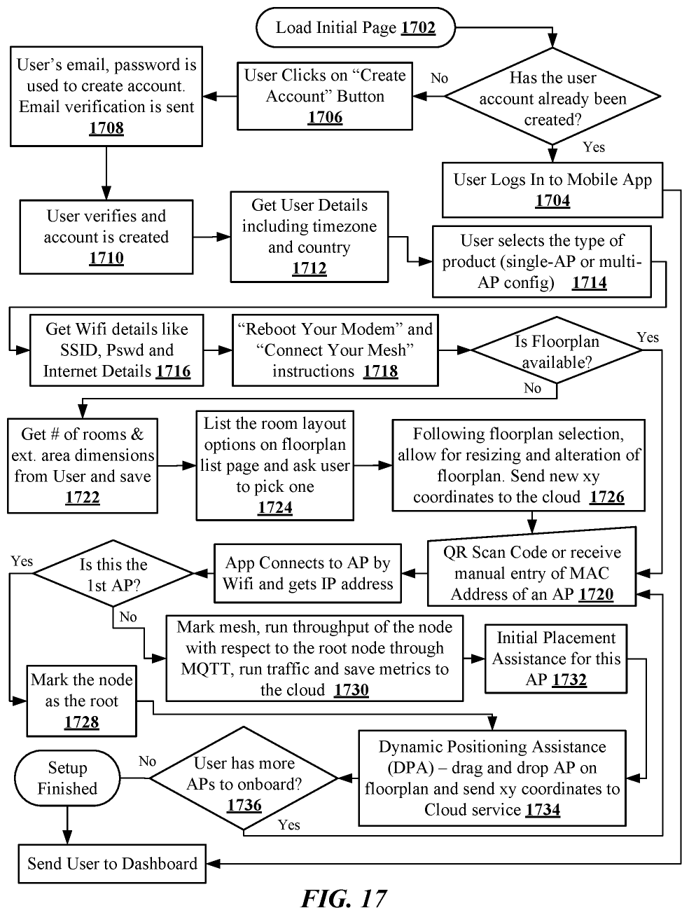

FIG. 17 shows a flow chart indicating how the mobile app may operate. While the following description is similar to the method descriptions accompanying FIGS. 2A-2C, it should be noted that the embodiments described with regards to FIG. 17 are specific to operation of a mobile application. As the following still relate to a similar process, in some cases the embodiments associated with FIGS. 2A-2C and 17 can be used interchangeably. At 1702, the mobile app may be configured to load an initial page. In some embodiments, the mobile app can take the form of a web application running on a web browser of a desktop computer, laptop computer or portable electronic device such that the initial page loads within an internet browser. Alternatively, the mobile app can also take the form of a native application running on a portable electronic device.

Regardless of the details of the mobile application architecture, at 1704 users that have already gone through a setup/configuration process are allowed to log in to the mobile app where a dashboard page is displayed on a display of a UE or STA running the mobile app. The log in process can take many forms including entry of a username and password entry or activation and/or validation of a login link provided to the user. In some embodiments, a user can use the dashboard to update or reconfigure the mobile app by running through many of the blocks depicted in FIG. 17.

In the event this is a first time log-in or the setup remains incomplete, the process continues to 1706 where the user selects the option to create or finish configuring a new account. At 1708, the mobile app can ask the user for verification of the user's identification prior to creating or finishing creation of the account. This account creation can include collection of the user's email, password and preferred user account name. At 1710, the user can be prompted to verify the entered email address by clicking a verification link received in an email verification email. At 1712, additional user details can be collected including a user's time zone, country, etc. At 1714 a user can be asked whether a single AP or multi-AP configuration is desired and for multi-AP configurations, the user can enter the number of APs to be included in the multi-AP configuration.

At 1716, the Wi-Fi® details can be collected (e.g., SSID, Pwd, etc.) from the user or the Wi-Fi® details can be imported from the UE running the mobile app, thereby allowing for communication between the UE and the APs being configured and monitored by the mobile app. At 1718, the mobile app can provide instructions to the user for rebooting a primary AP/modem/wireless gateway and for connecting multiple APs to the primary AP for forming a mesh Wi-Fi® system. It should be noted that depending on the AP hardware and features of the APs making up the mesh Wi-Fi® system a reboot of the APs may or may not be required.

Following connection of the APs, a user can be given the opportunity to provide a floorplan for a property where the Wi-Fi® mesh system is being installed. In some embodiments, a user can manually provide a floorplan file describing specific dimensions of the property. In other embodiments, the mobile app can be configured to retrieve the floor plan from a repository of property records maintained by the developer of the mobile app or from a public repository of property records. The method continues at 1720 when the mobile app receives the floor plan. When a floorplan is not available, the mobile app at 1722 can be configured to ask the user for the number of rooms, external area dimensions, desired room layout. These inputs can include the user selecting an exemplary floor plan corresponding to the initial inputs from a variety of exemplary floor plans. At 1726, the user can be allowed to resize and alter the room layout of the selected floor plan. These resizings/alterations may be saved via the backend server associated with the mobile app. In some embodiments, a user may be asked to also input the location of accessible electrical outlets. This may assist the STA finder with movement recommendations for a respective AP. For example, an AP movement recommendation can be limited to a threshold distance from an electrical outlet. For example, the threshold could be a maximum of 3-6 feet.

At 1720, (ix) a QR scan code for the MAC address of an AP may be requested, or IP address may be collected using Wi-Fi® Connect, or MQTT may be used to identify the broker's IP based on the broadcast IP. This IP address information allows the mobile app to connect to the AP.

At 1728, when the AP is the first AP, the AP is identified as the root. At 1730, when a respective AP is not the first AP, the respective AP is marked as a mesh AP, the throughput between the root AP and the respective mesh AP is determined, and metrics are saved to the backend server. At 1732, an initial placement for the AP is provided to the user. In some embodiments, initial placement of the AP can be based on establishing even distribution of the APs across the floorplan in order to maximize signal strength throughout the property. Unfortunately, different characteristics of a property, such as walls and other signal attenuating features, often limit the ability of a Wi-Fi® signal to propagate throughout a particular property as expected. At 1734, the dynamic positioning assistance (DPA) system can allow a user to indicate a position where the respective AP is placed by the user on the floorplan. This placement is then sent to the cloud service for further consideration. This placement may vary from the position recommended by the initial placement assistance. For example, a user could vary the placement as a result of power outlet availability, the location of other related electronic equipment and/or the user's aesthetic preferences. In some embodiments, the DPA can be configured to continually provide updated positioning recommendations based on received signal strengths measured while deploying the APs. The DPA can also be configured to request the user maneuver a STA across the property in order to provide initial data to the STA finder and associated DPA indicating the mesh Wi-Fi® system's performance in various areas of the property. When the user has sufficient time to maneuver the STA in this manner, the on-boarding process can involve requests to reposition the APs to achieve a more ideal configuration of APs. At 1736, the process can return to block 1720 if more APs remain to be replaced. In the event all APs have been on-boarded, setup is complete and the user is sent to the user dashboard.

The following provide examples of the performance characteristics according to embodiments of the present disclosure.

### Example 1: Network View of STAs Connected to a Router

In an example, two STAs were connected to a primary AP by way of Wi-Fi® signals running on substantially different frequencies. One runs in 2G (i.e. 2.4 GHZ) and the other in 5G (i.e. 5 GHz). They were running traffic between them. As viewed in the network, the list of STAs was identified as shown by the following which provided for each STA: (i) a media access control (MAC) address, (ii) a signal strength, and (iii) a connection time, as shown in Table (11) below:

TABLE 11
Network View of Connected STAs

| | |
|---|---|
| qbcml: | Mesh peers: |
| qbcml: | UID: 04:d9:f5:c1:79:40 [BSSID: 06:d9:f5:c1:79:40, |
| | STATIONS: 1] |
| qbcml: | ASSOC STA: 7c:78:7e:3b:de:df signal: −43 conntime: 344s |
| | (capab 0xd, flags 0x0) |
| qbcml: | UID: 04:d9:f5:c1:79:40 [BSSID: 06:d9:f5:c1:79:44, |
| | STATIONS: 1] |
| qbcml: | ASSOC STA: 84:ef:18:b6:70:0b signal: −62 conntime: 450s |
| | (capab 0x6, flags 0x80) |

In the same example, the traffic usage statistics were identified as shown in Table (12) below for the 2G STA.

TABLE (12)
2G Traffic Usage Statistics

Nmeshd: {
“version”: “1.1”,
“host”: “qubercomm.com”,
“uid”: “04:d9:f5:c1:79:40”,
“radio_stats”: “Qubercloud Manager”,
“cid”: “60881add87e0697fe387cbce”,
“radio_type”: “2.4Ghz”,
“radio_intf”: “1”,
“radio_free_pc”: 21,
“chan_free_pc”: 97,
“noise”: −111,
“vap_id”: 0,
“vap_mac”: “06:d9:f5:c1:79:40”,
“vap_ssid”: “srinitest”,
“_vap_tx_bytes”: 5540918444,
“_vap_rx_bytes”: 210935,
“vap_tx_pkts”: 3665526,
“vap_rx_pkts”: 834,
“client_count”: 1,
“vap_status”: “active”,
“peer_list”: [ {
“peer_index”: 0,
“peer_mac”: “7c:78:7e:3b:de:df”,
“_peer_tx_bytes”: 40631155,
“_peer_rx_bytes”: 5512,
“peer_tx_pkts”: 26880,
“peer_rx_pkts”: 24,
“peer_rssi”: −38,
“peer_retry”: 0,
“peer_tx_fail”: 0,
“peer_inact”: 760,
“peer_conntime”: 5,
“peer_bw_usage”: 85,
“peer_exp_tput”: 72,
“wlan_type”: “HT”,
“peer_os”: 255,
“11v”: true,
“11k”: true,
“11r”: false } ]

The preceding table shows that the 2G STA was provided a network throughput offer of about 72 Mbps (i.e., “peer_exp_tput”: 72) and was using about 85% of the 72 Mbps of the network throughput offer (i.e., “peer_bw_usage”: 85).

In the same example, the traffic usage statistics were identified as shown in Table (13) below for the 5G STA:

TABLE (13)
5G Traffic Usage Statistics

Nmeshd: {
“version”: “1.1”,
“host”: “qubercomm.com”,
“uid”: “04:d9:f5:c1:79:40”,
“radio_stats”: “Qubercloud Manager”,
“cid”: “60881add87e0697fe387cbce”,
“radio_type”: “5Ghz”,
“radio_intf”: “2”,
“radio_free_pc”: 51,
“chan_free_pc”: 99,
“noise”: −106,
“vap_id”: 0,
“vap_mac”: “06:d9:f5:c1:79:44”,
“vap_ssid”: “srinitest”,
“_vap_tx_bytes”: 494391,
“_vap_rx_bytes”: 1002686719,
“vap_tx_pkts”: 1733,
“vap_rx_pkts”: 664427,
“client_count”: 1,
“vap_status”: “active”,
“peer_list”: [ {
“peer_index”: 0,
“peer_mac”: “84:ef:18:b6:70:0b”,
“_peer_tx_bytes”: 444094,
“_peer_rx_bytes”: 1015973056,
“peer_tx_pkts”: 1283,
“peer_rx_pkts”: 664513,
“peer_rssi”: −64,
“peer_retry”: 0,
“peer_tx_fail”: 0,
“peer_inact”: 0,
“peer_conntime”: 468,
“peer_bw_usage”: 31,
“peer_exp_tput”: 203,
“wlan_type”: “VHT”,
“peer_os”: 255,
“11v”: false,
“11k”: false,
“11r”: false } ] }

The preceding table shows that the 5G STA was provided a network throughput offer of about 203 Mbps (i.e., “peer_exp_tput”: 203) and was using about 31% of the 203 Mbps of the network throughput offer (i.e., “peer_bw_usage”: 31).

In the same example, a view of the application initiating traffic as shown in Table (14) below for the 5G STA:

TABLE 14
5G Application Initiation for 5G STA

gitcode/certs$ iperf -c [app IP address] -u -b 60M -t 43434 -i 1
------------------------------------------------------------
Client connecting to [app IP address], UDP port 5001
Sending 1470 byte datagrams, IPG target: 186.92 us (kalman adjust)
UDP buffer size: 208 KByte (default)
------------------------------------------------------------
[ 3] local [station IP address] port 47192 connected with [app IP
address] port 5001
[ ID] Interval Transfer Bandwidth
[ 3] 0.0- 1.0 sec 7.50 MBytes 62.9 Mbits/sec
[ 3] 1.0- 2.0 sec 7.50 MBytes 62.9 Mbits/sec
[ 3] 2.0- 3.0 sec 7.50 MBytes 62.9 Mbits/sec
[ 3] 3.0- 4.0 sec 7.50 MBytes 62.9 Mbits/sec
[ 3] 4.0- 5.0 sec 7.50 MBytes 62.9 Mbits/sec
[ 3] 5.0- 6.0 sec 7.50 MBytes 62.9 Mbits/sec
[ 3] 6.0- 7.0 sec 7.50 MBytes 62.9 Mbits/sec

### Example 2: Mobile App Functionality

A Mobile App was configured as a Cloud Mobile App (CMA). A few different libraries were used, such as—‘fabricJS’ or ‘goJS’—to be used for rendering user interface components in CMA. Using the libraries, pre-defined templates were created as images and stored along with equivalent Cartesian coordinates for subsequent rendering. These templates were shown as images for selection in the CMA.

The user was asked for the number of rooms in the place of installation. Templates were displayed based on the number. Once an image was selected, the equivalent template was displayed in the next page in editable format. The external boundary of the layout was non-editable and its dimensions fetched first. There were text boxes for the individual rooms to display their respective dimensions. Users could move around the walls of the rooms or make changes in the dimensions displayed in the text boxes. The edges of the rooms did not go beyond the walls of the external boundary of the layout.

Once the user completed editing the layout, the current workflow of choosing a location name for the ROOT router followed. After this, the user interface page allowed for a QR code scan of the device or for manual entry of the device. Onboarding of the ROOT node followed. When onboarding succeeded, CMA sent details of the onboarding process.

CMA provided the layout again with a palette of icons like the NMesh router and any static clients that could be displayed on the layout. Users clicked and pointed to place the icons on the layout. The user chose the ROOT node that was on-boarded and any static client connecting to it. Once the user clicked on the “Placement Assistance” button, the Cartesian coordinates of the corners of the rooms and the external boundary and also of the icons were sent to Cloud Backend Services (CBS) for storing and further processing (using representational state transfer applications programming interfaces (REST APIs).

CBS sent the layout, device, and other client details to an algorithm module to calculate the dynamic placement assistance (DPA). CBS forwarded the results back to CMA for display on the chart. If there was a suggestion for a change, suitable icons of different colors were used on the layout at the proposed location. When the user wanted to make use of or experiment with a different location of either the router or the clients to see the performance, the user clicked the “Placement Assistance” button. This process continued with all the mesh nodes, as well, after the onboarding process of that node completed.

When the results from DPA were “Too near” or “Too far” and the user had candidate points for repositioning, the user choose (1 or 2) and sent the candidate points for assistance. Some optional items included candidate points for routers, static clients available in the layout, user-initiated or DPA-initiated items, and evaluation of frequently used positions of the client(s).

### Example 3: STA Finder Demonstration

In this example, data was collected by walking from corners towards each of the routers with STA finder tracking approaching movement. The CMA was used to view the heat-map. The STA finder outputted a cross check of “estimated STA zones” vs “real route.”

### Demonstration #1:

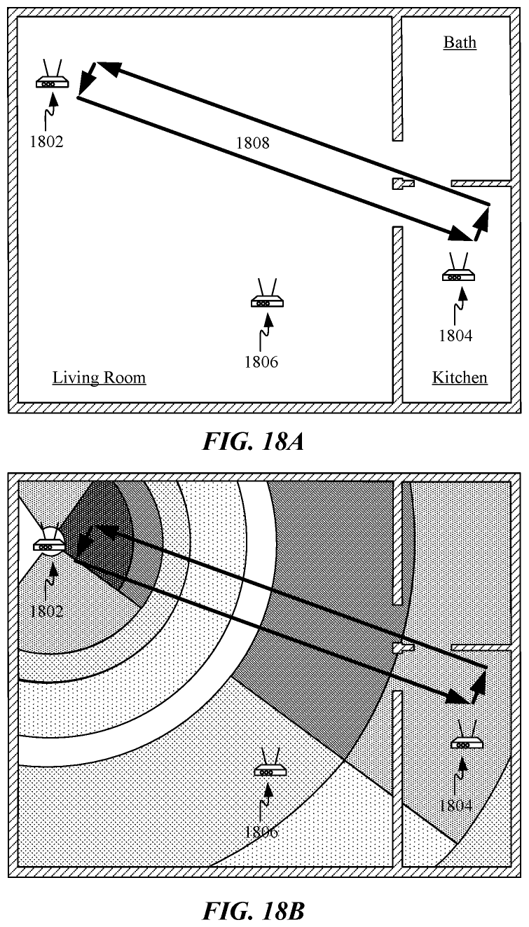

FIG. 18A shows an exemplary floorplan that includes APs 1802, 1804 and 1806. The floorplan and AP configuration can be setup as part of the process described in the text accompanying FIG. 17, RSSI data was collected while a STA was moved along path 1808 that takes the STA from AP 1802 in the living room and walking toward AP 1804 in the kitchen and back to AP 1802 multiple times in a rectangular pattern. Moving the STA in this manner allows multiple STA zones and associated data to be established within a database of STA zones using the inside out and outside in methods described herein. In some embodiments, a user can opt to collect additional RSSI data over a period of time and incorporate it into the database using the inside out, outside in and methods that don't include a STA crossing a CZ as described in the text accompanying FIG. 16.

FIG. 18B shows how a heat zone map can be generated based on the RSSI data collected during use of the configuration of APs shown in FIGS. 18A and 18B. The STA zones can be color coded in accordance with frequency of use and referred to as access zones. Darker access zones indicate zones in which the STA spent more time.

### Demonstration #2: Identifying Poor Coverage Zones

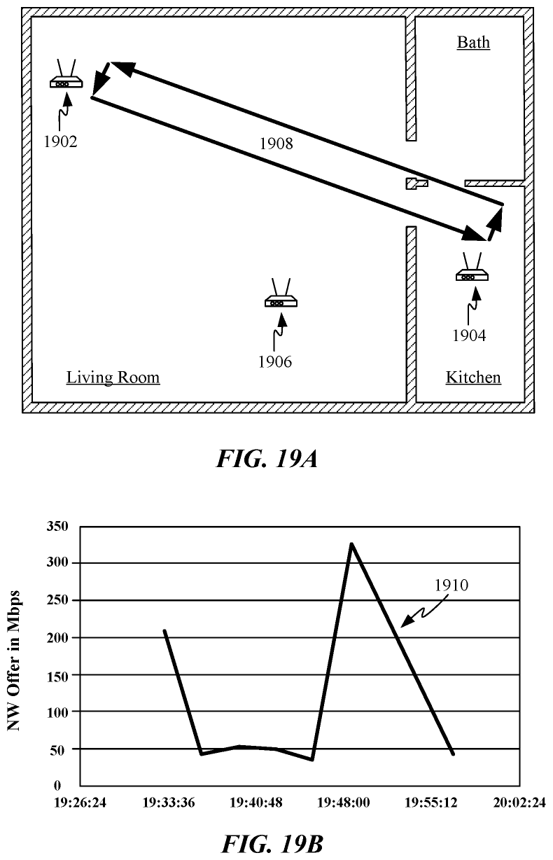

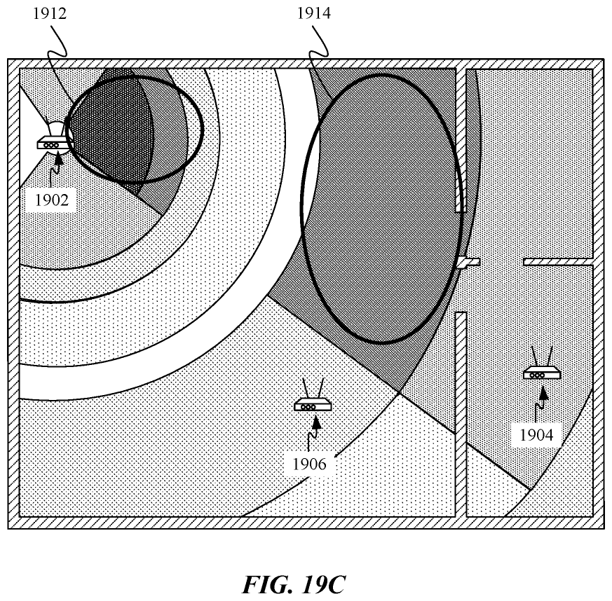

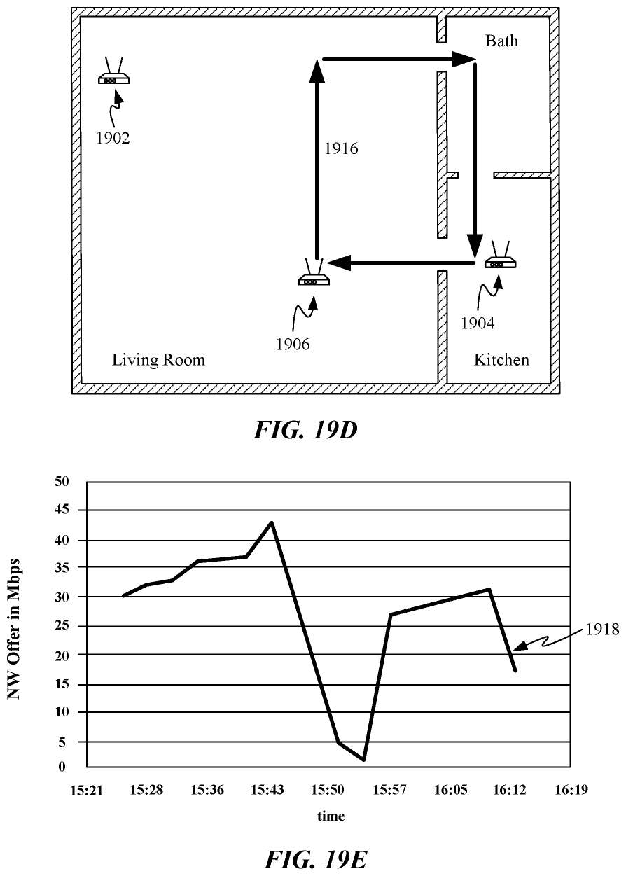

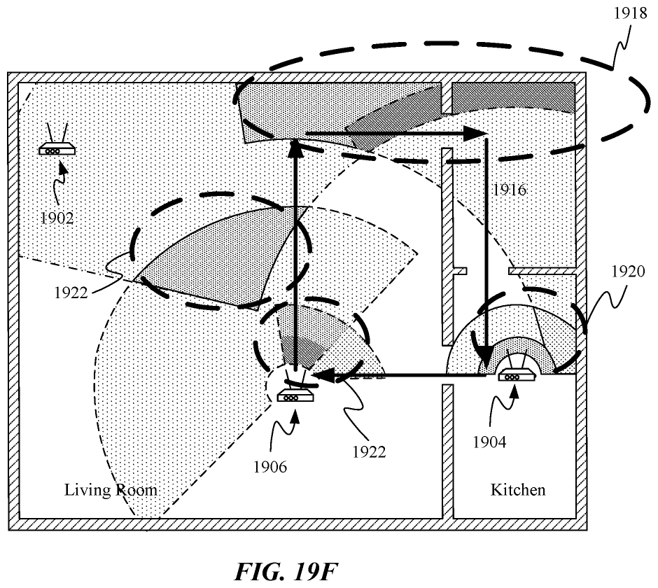

FIG. 19A shows a floorplan that includes APs 1902, 1904 and 1906 as well as a path 1908 traversed by a STA for the purpose of evaluating Wi-Fi® coverage across the floorplan. FIG. 19B shows a plot 1910 representing Wi-Fi® coverage performance during a period of about 30 minutes. In particular, performance is particularly poor for about 10 minutes from 19:35 to 19:45. This plot can be generated from log data that is also associated with the STA zone positioning data.

FIG. 19C shows a heat map generated based on the RSSI data collected as described previously and overlaid with indicia indicating locations or zones with high usage. High usage zones 1912 and 1914 are called out by ellipses. When the Wi-Fi® performance data associated with high usage zone 1912 is evaluated, this zone is not deemed to have any issues with good Wi-Fix coverage. This is unsurprising given the proximity of this zone to AP 1902. High usage zone 1914, which could correspond to the location of a couch or other resting/working area is located somewhat equidistantly from APs 1902, 1904 and 1906. When the portion of log data used to generate FIG. 19B that corresponds to high usage area 1914 is analyzed the system identifies high usage area 1914 as a location likely suffering from poor Wi-Fi® coverage. This type of analysis would generally be performed by AP performance analyzer 304 from FIG. 3, which helps identify and locate regions of a floorplan where the wireless mesh network is performing poorly.

### Demonstration #3: Using STA Zone Data to Identify Poor Coverage Zones

FIG. 19D shows another exemplary path 1916 performed for the same floorplan and AP layout used in FIGS. 18A-19C. Path 1916 that differs from path 1908 and extends between APs 1904 and 1906 instead of between APs 1902 and 1904. Path 1916 also differs due to its geometry being closer to a square in shape, allowing the path to cover a larger portion of the floorplan and having a higher likelihood of generating RSSI data and performance data for multiple STA zones. By placing APs at adjacent corners of rectangular path 1916, three of the four legs of rectangular path 1916 can be used with the inside out or outside in techniques described herein, while RSSI values along the fourth leg can be analysed using the techniques described in FIG. 16.

FIG. 19E, in a similar manner to FIG. 19B, shows a plot 1910 representing Wi-Fi® coverage performance but for a period of about 45 minutes.

The heat map shown in FIG. 19E illustrates how path 1916 results in the STA zones being primarily defined in relation to APs 1904 and 1906 and not AP 1902 as was the case in the heat map depicted by FIG. 19C. This is due primarily to path 1916 guiding the STA through the CZ of APs 1904 and 1906 and not the CZ of AP 1902. Similar to FIG. 19D, FIG. 19E shows In some embodiments, a user can be asked to walk path 1916 multiple times. The heat map shown in FIG. 19G corresponds to the user maneuvering a STA along path 1916 15 times with a 15 s pause between each traversal of the path). In some embodiments, a user could be asked to walk both paths 1916 and 1908 in the event more detailed performance and location information is desired. Alternatively, the user could be provided a path that includes all of the APs for a respective floorplan. The mobile app may offer multiple paths as an optional feature to avoid a situation in which a user believe the on-boarding process is overly time consuming. The heat map STA zones also include data other than data generated from the user traversing path 1916. In particular, this additional STA movement information is why STA zones offset from path 1916 are shaded showing at least some amount of STAs operating away from path 1916.

FIG. 19F also includes multiple dashed ellipses identifying darker STA zones within the heat map. By analysing data associated with the darker zones, a device is able to more quickly identify problem areas as the darker areas generally contain a majority of the positioning data and consequently is more likely to have performance data falling below a minimum performance threshold. In particular, ellipse 1918 shows STA zones associated with positioning data falling below the minimum performance threshold. In particular, the performance data between times 15:48 and 15:56 could be associated with STA zones identified by ellipse 1918. Ellipses 1920 and 1922 also identify darker STA zones but due to their proximity to APs 1904 and 1906 respectively their associated log data indicating Wi-Fi® performance do not show degraded performance. Ellipse 1922 indicates a STA zone with possible performance issues. This could be the case in the event the STA zone indicated by ellipse 1922 corresponds to times 15:56 to 15:58, which contain a mix of low and middling Wi-Fi® performance.

### Example 4: STA Finder Enhancements

Input from a UE or STA may be collected by (a) receiving the router's room name during on-boarding; (b) adding a drag-and-drop option to change the router's location in the topology diagram during runtime.

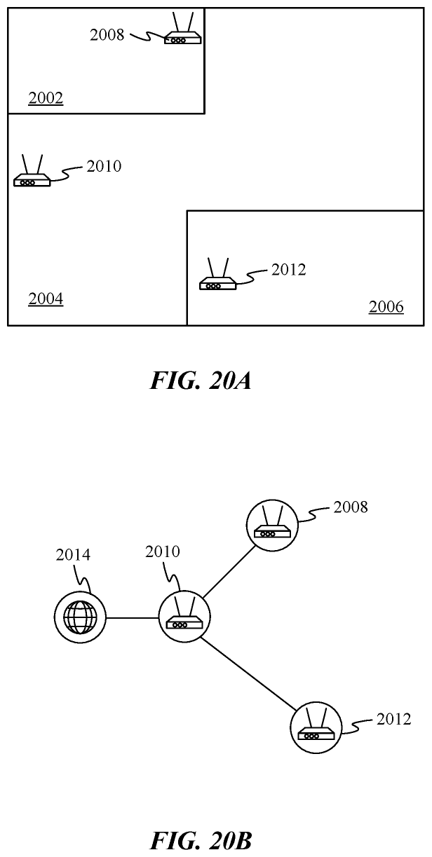

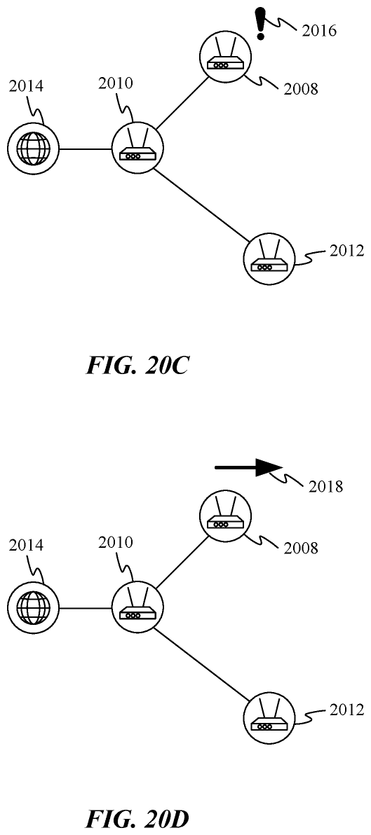

As shown in FIG. 20A, in one example, input may be collected from a user equipment (UE) by first getting the floor-map, floor dimensions, and access point locations from a user interface. In some embodiments, a user can also be asked for the location of power outlets to assist the STA finder with making feasible recommendations for AP movement.

FIG. 20A shows the floor-map including a kitchen 2002, an office 2004 and a bedroom 2006 with each room containing an AP. AP 2008 is located in kitchen 2002, AP 2010 is located in office 2004 and AP 2012 is located in bedroom 2006. Following collection of the data used to configure the floor map depicted in FIG. 20A a STA finder module and a router performance analyser module can be used to identify poor coverage zones.

In some embodiments, a topology diagram may be used to display relative access point locations, and the user interface may be configured to allow for dragging and placing the location of the routers in the topology diagram, as shown in FIG. 20B. This can be helpful feature for users desiring to bypass the step of inputting a floor map or floor dimensions. FIG. 20B also indicates how AP 2010 is the primary AP/router connected to an internet service provider 2014. The internet service provider can be delivered using multiple mediums including, e.g., by a hybrid fiber coaxial (HFC) network, a fiber network or a DSL network. In some embodiments, a user can be asked to confirm a distance between APs when the distance entered falls outside a distance range indicated by RSSI values from one or more other adjacent APs. This can be helpful as the more accurate the AP positioning data is the more accurate the positioning of the STA zones will be.

In some embodiments, performance root-cause identifier module 306 may be used to identify if router relocation is the cause of the “poor coverage,” and a static client list may be maintained and STA zones may be identified.

While static clients have been mentioned in passing, a static client refers to any STA that maintains a fixed position within a mesh Wi-Fi® network. Examples of static clients can include a desktop computer, a printer, a connected television, a connected refrigerator, or the like. In a home where a user always operates a laptop computer from a particular location, the laptop computer though generally thought of as a portable electronic device could be considered a static client for purposes of this analysis.

In some embodiments, a mobile app may be used to draw an imaginary floor around the topology diagram to send to a backend server. The AP performance analyser module 304 may evaluate performance of APs and identify poor coverage time windows.

In some embodiments, with respect to static clients: (i) a list of static wireless clients may be identified, (ii) for each static client, the device name may be identified by name based on purpose (e.g., Samsung® AC, Canon® Printer, Desktop, or the like) by a default moniker of the device or by a name customized by the user, and (iii) the zone may be identified and saved on the backend server.

In some embodiments, STA finder module 302 may be configured to periodically identify zones for each of the connected wireless clients.

In some embodiments, (i) for router-relocation cases, new zones may be identified for the router in question, (ii) for static clients, the references of a static client may be used if one or some is part of the new zone in which the same location is used as the router's new location, and (c) when no static clients are present in the new zone, no action may occur in response. In some embodiments, RSSI readings from the static client can be used to confirm the new zone should or should not include the position of the static client. For example, where RSSI values for the STA used to create the new zone are substantially different than RSSI values collected from the static client at the same time, the new zone can be moved and/or resized so as not to include the position of the static client.

In some embodiments, a symbol may be displayed on top of the AP in the topology diagram to denote that the router may be repositioned to receive enhanced coverage (b) and text may be displayed to maintain the router near the identified static client.

In some embodiments, as shown in FIG. 20C, a “!” symbol 2016 may be used to indicate that the router should be relocated closer or proximate to a selected static client. In some embodiments, the static client can also be highlighted or otherwise called out to a user so that the user is able to easily determine which static client AP 2008 should be moved toward. In some embodiments, the user can be instructed to move the AP next to or proximate the static client. Collocating the AP and static client eliminates risk that the new location does not have access to an electrical outlet as a static client will generally be plugged in to a power outlet. It should be noted that, the “!” symbol is used for exemplary purposes only and any indicia recognizable to a user can be used to ask that the AP be moved closer to a selected static client.

In another example, and as shown in FIG. 20D, an exemplary arrow 2018 can be used to both indicate relocation is recommended and provide the direction of movement for the router to increase the coverage and/or performance of the mesh wireless network. Arrow 2018 can be referred to as a reposition indicia that is displayed for a selected period of time (e.g., a few days) so that the user may be reminded to move the AP/router to provide more or improved coverage. In some embodiments, a size of the reposition indicia can vary in accordance with the amount of movement being requested. In a use case where a full floor layout is displayed, an additional indicia can be added to show the approximate location recommended for AP 2008.

In some embodiments, a change in router location may be identified by: (i) determining whether the reference static client has a stronger RSSI with the router moved next to it, or (ii) compare other routers' RSSI to determine the location change. The icon once may no longer be displayed once it has been confirmed that the router is repositioned to a different location.

In some embodiments, when the performance of the router has not been increased after relocation of the router has been identified, the icon may be displayed again and a request may be displayed to move the router to a proper location.

In some embodiments, when the solution identification module does not identify an increased coverage area to which the router may be moved, then a relocation suggestion may not be displayed.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

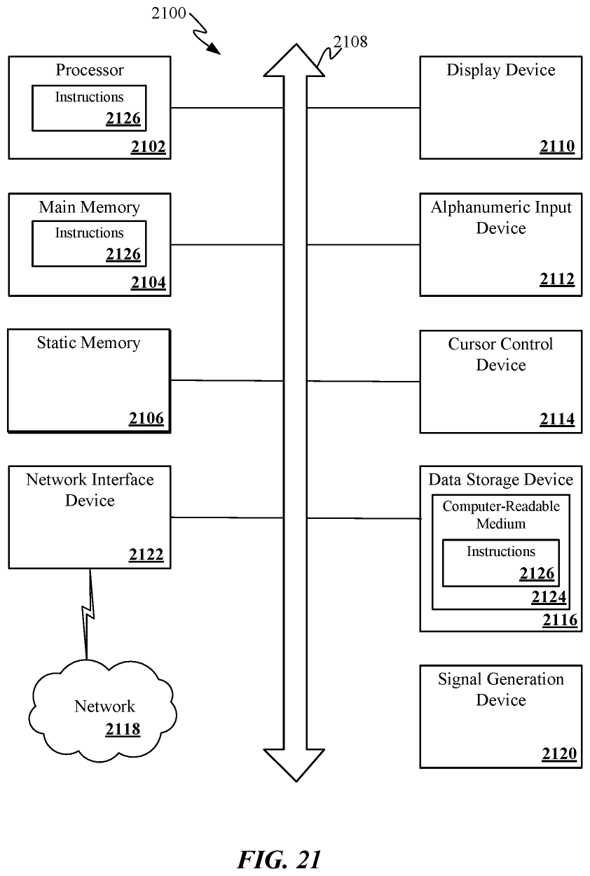

FIG. 21 illustrates a diagrammatic representation of a machine in the example form of a computing device 2100 within which a set of instructions, for causing the machine to perform any one or more of the methods discussed herein, may be executed. The computing device 2100 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative embodiments, the machine may be connected (e.g., networked) to other machines in a LAN, an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 2100 includes a processing device (e.g., a processor) 2102, a main memory 2104 (e.g., read-only memory (ROM), flash memory, dynamic random access memory (DRAM) such as synchronous DRAM (SDRAM)), a static memory 2106 (e.g., flash memory, static random access memory (SRAM)) and a data storage device 2116, which communicate with each other via a bus 2108.

Processing device 2102 represents one or more general-purpose processing devices such as a microprocessor, central processing unit, or the like. More particularly, the processing device 2102 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 2102 may also include one or more special-purpose processing devices such as an application specific integrated circuit (ASIC), a field programmable gate array (FPGA), a digital signal processor (DSP), network processor, or the like. The processing device 2102 is configured to execute instructions 2126 for performing the operations and steps discussed herein.

The computing device 2100 may further include a network interface device 2122 which may communicate with a network 2118. The computing device 2100 also may include a display device 2110 (e.g., a liquid crystal display (LCD) or a cathode ray tube (CRT)), an alphanumeric input device 2112 (e.g., a keyboard), a cursor control device 2114 (e.g., a mouse) and a signal generation device 2120 (e.g., a speaker). In at least one embodiment, the display device 2110, the alphanumeric input device 2112, and the cursor control device 2114 may be combined into a single component or device (e.g., an LCD touch screen).

The data storage device 2116 may include a computer-readable storage medium 2124 on which is stored one or more sets of instructions 2126 embodying any one or more of the methods or functions described herein. The instructions 2126 may also reside, completely or at least partially, within the main memory 2104 and/or within the processing device 2102 during execution thereof by the computing device 2100, the main memory 2104 and the processing device 2102 also constituting computer-readable media. The instructions may further be transmitted or received over a network 2118 via the network interface device 2122.

While the computer-readable storage medium 2126 is shown in an example embodiment to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

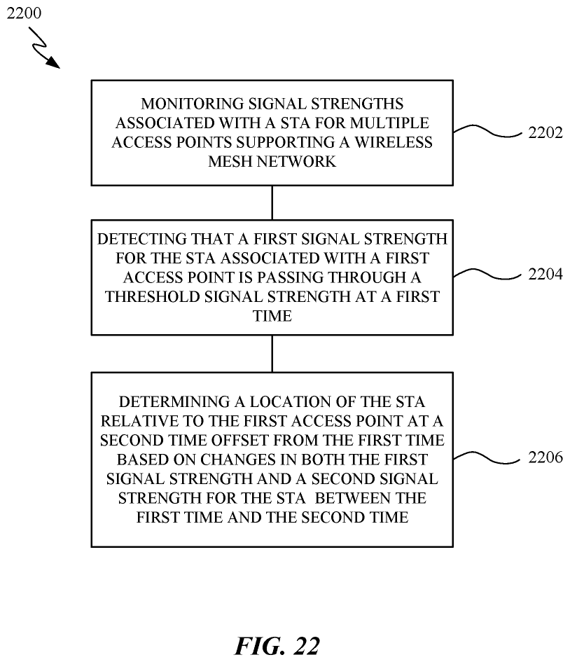

FIG. 22 shows a flow diagram describing a method for determining a location of a STA operating on a mesh wireless network. At 2202, signal strengths associated with a STA are monitored for a group of access points supporting the mesh wireless network. At 2204, a processor responsible for monitoring the signal strengths detects that a first signal strength for the STA associated with a first AP passes through a threshold value indicating the STA has passed through a confidence zone (i.e. a circle with a radius of between 5-10 m centered on the AP) associated with the primary AP. The received signal strengths or RSSI can be measured at the STA or at each of the APs.

At 2206, a location of the STA relative to the first AP is determined at a second time offset either before or after the first time. The second time is chosen because it's desirable to measure the performance of the STA farther away from the AP since performance of the network at the boundary of the CZ is generally at its peak or at least very good. This gives the analysis the opportunity to analyze areas more likely to have problematic coverage. The second time can correspond to a time relatively close in time to the first time where the STA is farther from the primary AP than at the first time. In some embodiments, this can be a fixed duration of time and in other embodiments the time period can be calculated based on changes in RSSI values being consistent with linear movement directly toward or away from the confidence zone of the first AP. In some embodiments, this linear movement time period can be identified by determining when a discontinuity in signal strength change is detected, thereby indicating a change in direction or linearity. In some embodiments, a maximum time interval can be applied, such as 5-10 seconds, in situations where an AP has a particularly long range or the STA is moving particularly slowly.

In some embodiments, a system can be configured to continuously sample RSSI readings. When, for example, a CZ crossing is detected going outside to inside, the system can be configured to review RSSI reading collections prior to the CZ crossing. In a situation where during the previous minute a STA headed in a first direction substantially tangential to the PR for 10 seconds and then turned and moved directly toward the PR for the next 30 seconds until crossing the CZ of the PR, the system would attempt to determine when the STA started linear movement toward the PR and effectively find the turning point 30 seconds prior to the CZ crossing. It can be configured to do this by dividing the preceding 64 seconds into 8 second intervals and go backwards in time to see which of the preceding 8 second intervals include a change in the rate at which RSSI values are changing to identify the end of linear movement toward the CZ. Once the 8 second interval is identified, the 8 second interval is divided into smaller intervals until a precise time of the turn is identified and then labeled as the second time. While the 64 second window is one useful way to divide up the time it should be recognized that other shorter or longer intervals such as 32 or 128 seconds could be used and are deemed to be within the scope of the disclosed embodiments.

For inside to outside instances the second time comes after the first time and for outside to inside instances the second time comes prior to the first time. The location determination is based on detected changes in the first signal strength and/or a second signal strength for the STA at or near the second time. For example, when the first signal strength is lower a threshold time period after the second time and higher a threshold time period after the second time then the first signal strength can be characterized as increasing in strength at the second time. Exemplary threshold time periods can be, e.g., between one and five seconds. A calculation can be performed using these changes in signal strength to determine a location of the STA. While the location is not exact, as described above the location takes the form of a STA zone generally hemi-spherical or quarter spherical in shape.

Some portions of the detailed description refer to different modules configured to perform operations. One or more of the modules may include code and routines configured to enable a computing system to perform one or more of the operations described therewith. Additionally or alternatively, one or more of the modules may be implemented using hardware including any number of processors, microprocessors (e.g., to perform or control performance of one or more operations), DSPs, FPGAs, ASICs or any suitable combination of two or more thereof. Alternatively or additionally, one or more of the modules may be implemented using a combination of hardware and software. In the present disclosure, operations described as being performed by a particular module may include operations that the particular module may direct a corresponding system (e.g., a corresponding computing system) to perform. Further, the delineating between the different modules is to facilitate explanation of concepts described in the present disclosure and is not limiting. Further, one or more of the modules may be configured to perform more, fewer, and/or different operations than those described such that the modules may be combined or delineated differently than as described.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of configured operations leading to a desired end state or result. In example implementations, the operations carried out require physical manipulations of tangible quantities for achieving a tangible result.

Unless specifically stated otherwise, as apparent from the discussion, it is appreciated that throughout the description, discussions utilizing terms such as detecting, determining, analyzing, identifying, scanning or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. Computer-executable instructions may include, for example, instructions and data which cause a general-purpose computer, special-purpose computer, or special-purpose processing device (e.g., one or more processors) to perform or control performance of a certain function or group of functions.

Although the subject matter has been described in language specific to structural features and/or methodological acts, it is to be understood that the subject matter configured in the appended claims is not necessarily limited to the specific features or acts described above. Rather, the specific features and acts described above are disclosed as example forms of implementing the claims.

Unless specific arrangements described herein are mutually exclusive with one another, the various implementations described herein can be combined in whole or in part to enhance system functionality and/or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A STA finder device, comprising:
a processing device configured to:
monitor signal strengths associated with a STA for each of a plurality of access points supporting a wireless mesh network;
detect that a first signal strength for the STA at a first access point of the plurality of access points is decreasing through a threshold signal strength at a first time; and
determine a location of the STA relative to the first access point at a second time following the first time based on changes in the first signal strength for the STA and/or a second signal strength for the STA at the second time.

2. The STA finder device of claim 1, wherein the second signal strength is associated with a second access point of the plurality of access points.

3. The STA finder device of claim 1, wherein the STA is farther away from the first access point at the second time than at the first time.

4. The STA finder device of claim 1, wherein the processing device configured to increase a sampling rate of the monitoring of the signal strengths following detection of the first signal strength decreasing through the threshold signal strength.

5. The STA finder device of claim 1, wherein the STA is the STA finder device.

6. The STA finder device of claim 1, wherein the processing device is further configured to:
prior to determining the location of the STA at the second time, determine the second time by calculating an amount of time subsequent to the first time where the STA moved in a linear direction based on the changes in the first signal and/or second signal strengths.

7. The STA finder device of claim 1, wherein the processing device is further configured to:
correlate performance of the wireless mesh network for the STA device at the second time with the location; and
in response to the performance of the wireless mesh network in the location falling below a performance threshold, generate a recommendation to move one or more of the plurality of access points to improve performance of the wireless mesh network in the location.

8. The STA finder device of claim 1, wherein the location is a STA zone defining a spatial area that is determined to include a position of the STA finder at the second time.

9. The STA finder device of claim 8, wherein the STA zone has a hemispherical shape or a quarter spherical shape.

10. The STA finder device of claim 8, wherein the STA zone is defined using a coordinate system based on a position of the first access point relative to the second access point of the plurality of access points and wherein a second signal strength for the STA at the second access point at the first time is less than the first signal strength and greater than any of the signal strengths received for the other access points of the plurality of access points at the first time.

11. The STA finder device of claim 1, wherein the first signal strength is a received signal strength indicator measured at the first access point.

12. A method, comprising:
monitoring signal strengths associated with a STA for each of a plurality of access points supporting a wireless mesh network;
detecting that a first signal strength for the STA at a first access point of the plurality of access points is decreasing through a threshold signal strength at a first time; and
determining a location of the STA relative to the first access point at a second time following the first time based on changes in the first signal strength for the STA and/or a second signal strength for the STA at the second time.

13. The method of claim 12, wherein the STA is farther away from the first access point at the second time than at the first time.

14. The method of claim 12, further comprising:
prior to determining the location of the STA at the second time, determining the second time by calculating an amount of time subsequent to the first time where the STA moved in a linear direction based on the changes in the first signal strength.

15. The method of claim 12, further comprising:
correlating performance of the wireless mesh network for the STA device at the second time with the location; and
in response to the performance of the wireless mesh network in the location falling below a performance threshold, generating a recommendation to move one or more of the plurality of access points to improve performance of the wireless mesh network in the location.

16. The method of claim 12, wherein the location is a STA zone defining a spatial area that is determined to include a position of the STA finder at the second time.

17. The method of claim 16, wherein the STA zone has a hemi-spherical shape or a quarter spherical shape.

18. The method of claim 17, wherein the STA zone is defined using a coordinate system based on a position of the first access point relative to the second access point of the plurality of access points and wherein a second signal strength for the STA at the second access point at the first time is less than the first signal strength and greater than any of the signal strengths received for the other access points of the plurality of access points at the first time.

19. The method of claim 12, wherein the first signal strength is a received signal strength indicator measured at the first access point.
